(19) United States
(12) Patent Application Publication
(10) Pub. No.: US 2022/0269943 A1
(43) Pub. Date: Aug. 25, 2022

(54) SYSTEMS AND METHODS FOR TRAINING NEURAL NETWORKS ON A CLOUD SERVER USING SENSORY DATA COLLECTED BY ROBOTS

(71) Applicant: Brain Corporation, San Diego, CA (US)

(72) Inventors: Botond Szatmary, San Diego, CA (US); David Ross, San Diego, CA (US)

(21) Appl. No.: 17/745,088

(22) Filed: May 16, 2022

Related U.S. Application Data
(63) Continuation of application No. PCT/US20/60731, filed on Nov. 16, 2020.
(60) Provisional application No. 62/935,792, filed on Nov. 15, 2019.

(51) Int. Cl. G06N 3/08; G06N 5/04

(52) U.S. Cl. CPC G06N 3/08; G06N 5/04

(57) ABSTRACT

Systems and methods for training neural networks on a cloud server using sensory data collected by plurality of robots is disclosed herein. The model may be derived from one or more trained neural networks, the neural networks being trained using data collected by one or more robots. Advantageously, data collection by robots may enhance consistency, reliability, and quality of data received for use in training one or more neural networks. The model may be utilized by robots, upon sufficient training of the neural networks, such that the robots may identify features within their environments. Advantageously, the model may be trained on a cloud server and utilized by individual robots for use in enhancing autonomy of the robots, wherein the utilization of the model requires significantly fewer computational resources than training of the neural networks to develop the model.

### PRIORITY

This application is a continuation of International Patent Application No. PCT/US20/60731 filed Nov. 16, 2020 and claims the benefit of provisional patent application 62/935,792, filed on Nov. 15, 2019, under 35 U.S.C. §§ 119, 120, the entire disclosure of each are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present application relates generally to robotics, and more specifically to systems and methods for training neural networks on a cloud server using sensory data collected by robots.

Currently, neural networks may be configurable to learn associations between inputs and outputs, called training pairs, by adjusting weights of a plurality of nodes therein. Training pairs may comprise, in some instances, images and annotations of the images, wherein the annotations correspond to classifications of pixels or regions within the images as one or more features. To train a neural network, a substantial number of training pairs are provided such that ideal weights of nodes of the neural network may be learned based on the training pairs. Annotating images, as well as labeling of other data types (e.g., point clouds, time dependent parameters, etc.), may be costly from both a time and labor perspective, however, providing labels may be necessary for training of a neural network to identify features.

Robots typically comprise one or more sensor units configurable to enable the robots to collect measurements of one or more parameters of an environment surrounding them. These sensor units may output data representing, at least in part, features of the environment such as particular objects (e.g., items on a supermarket shelf), features of the objects (e.g., shape, color, size, etc.), and/or time dependent trends of objects (e.g., location and velocity) or things (e.g., temperature fluctuations). Robots may be configurable to navigate predetermined route(s) during operation, wherein the robots may collect data of features of their environments using their sensor(s). Additionally, some robots may comprise varying computing power from others. Computing power of a robot may change over time based on when a robot is and is not performing a task as well as a complexity of the task being performed, therefore, some robots may further comprise unutilized computing resources. Accordingly, there is a need in the art for systems and methods for training of neural networks on a cloud server using sensory data collected by robots.

The foregoing needs are satisfied by the present disclosure, which provides for, inter alia, systems and methods for training neural networks on a cloud server using sensory data collected by robots.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a method for training one or more neural networks to develop a model for use in enhancing functionality of one or more robots is disclosed. The method comprises receiving sensor data from one or more sensor units of one or more robots; receiving labels of the received sensor data, the labels comprising identified at least one training feature within the sensor data; utilizing the received sensor data and the labels to train the one or more neural networks to develop the model to identify the at least one training feature; and communicating the model to one or more robots upon the model achieving a training level above a threshold value. The training level corresponding to an accuracy of the model, the accuracy being based on a training process of the one or more neural networks. The method may further comprise receiving sensor data from one or more sensor units of a first robot; communicating the sensor data to a second robot, the second robot comprising the model trained to identify the at least one training feature; generating an inference by the second robot based on the model, the inference comprising detection, or lack thereof, of the at least one training feature within the sensor data; and communicating the inference to, at least, the first robot.

According to at least one non-limiting exemplary embodiment, the method may further comprise utilizing the model to identify one or more of the training features within sensor data acquired by a robot at a location; localizing or locating the robot at the location; and correlating the location of the robot with the training features observed at the location. The method may further comprise the robot utilizing the correlation between the location of the robot and the features observed to, during subsequent navigation at the location, determine if at least one of one or more of the training features are missing or one or more additional training features are detected at the location; and performing a task based on the training features, or lack thereof, detected at the location deviating from the training features detected at the location during prior navigation at the location, the detection of the training features being performed using the model. The task comprises at least one of the robots navigating a route, emitting a signal to alert a human or other robots of the change in the observed training features, or uploading sensor data captured at the location for use in enhancing the model.

According to at least one non-limiting exemplary embodiment, the method may further comprise receiving sensor data from a third robot; detecting none of the training features are present within the sensor data using the model; and receiving labels of the sensor data to further train the model to identify at least one additional feature, the further training of the model comprises training of at least one neural network to identify the at least one additional feature.

According to at least one non-limiting exemplary embodiment, the method may further comprise enhancing the model using additional training pairs, the training pairs comprising sensor data acquired by the one or more robots and labels generated for the sensor data subsequent to the communication of the model to the one or more robots; and communicating changes to the model based on the additional training pairs to the one or more robots which utilize the model.

According to at least one non-limiting exemplary embodiment, the method is effectuated by a cloud server. The cloud server may comprise a distributed network of controllers and processing devices executing computer readable instructions, the distributed network of controllers and processing devices being located on the one or more robots and devices (e.g., dedicated processing units, user interfaces, IoT devices, etc.) coupled to the cloud server. The model is representative of learned weights of the one or more neural networks, the one or more neural networks being trained using labels of the sensor data in accordance with a training process.

According to at least one non-limiting exemplary embodiment, a method for training a model and communicating the model to a robot to enhance functionality of the robot is disclosed. The method may comprise training of one or more neural networks using sensor data acquired by one or more robots. The sensor data may be provided to an annotator configurable to label the sensor data such that the sensor data in conjunction with the labels may be utilized to train one or more neural networks 300 to identify one or more training features within the sensor data. The method may further comprise communicating the model derived from the one or more neural networks to one or more robots. The model being based on learned weights of the one or more neural networks, the weights being learned using the sensor data and labels thereto. The method being effectuated by a cloud server comprising a distributed network of processing devices and controllers on robots and devices coupled to the cloud server.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some exemplary embodiments of this disclosure.

FIG. 1B is a functional block diagram of a controller or processing device in accordance with some exemplary embodiments of this disclosure.

FIG. 2 is a functional block diagram illustrating a cloud server and coupled devices and robots thereto in accordance with some exemplary embodiments of this disclosure.

FIG. 3 is a simplified neural network in accordance with some exemplary embodiments of this disclosure.

FIG. 4 is a functional block diagram of a system configurable to train a neural network to develop a trained model for use by one or more robots to identified one or more training features, according to an exemplary embodiment.

FIG. 5 is an image captured by an RGB camera and annotations of pixels of the image, according to an exemplary embodiment.

FIG. 6 is a process flow diagram illustrating a method for a cloud server to train and deploy a model for use by robots to detect one or more training features, according to an exemplary embodiment.

FIG. 7 illustrates data uploaded to a cloud server over time for use in training one or more neural networks, according to an exemplary embodiment.

FIG. 8 illustrates an exemplary use case of the systems and methods of this disclosure to perform feature detection using a trained model, according to an exemplary embodiment.

FIG. 9A is a functional block diagram of a system configurable to train a plurality of neural networks to identify a plurality of respective training features, according to an exemplary embodiment.

FIG. 9B-C illustrates a histogram of features detected by a robot at a given location of the robot for use, in part, for in minimizing data uploaded to a cloud server, according to an exemplary embodiment.

FIG. 10 is a process flow diagram illustrating a method for a first robot to receive an inference based on sensor data collected by the first robot and a model on a second robot, according to an exemplary embodiment.

FIG. 11 is a process flow diagram illustrating broadly the systems and methods of this disclosure, according to an exemplary embodiment.

All Figures disclosed herein are © Copyright 2020 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting the scope of the disclosure being defined by the appended claims and equivalents thereof.

The present disclosure provides for systems and methods for training neural networks on a cloud server using sensory data collected by robots. As used herein, a robot may include mechanical and/or virtual entities configurable to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another. Examples of robots mentioned herein are merely illustrative and not meant to be limiting in any way.

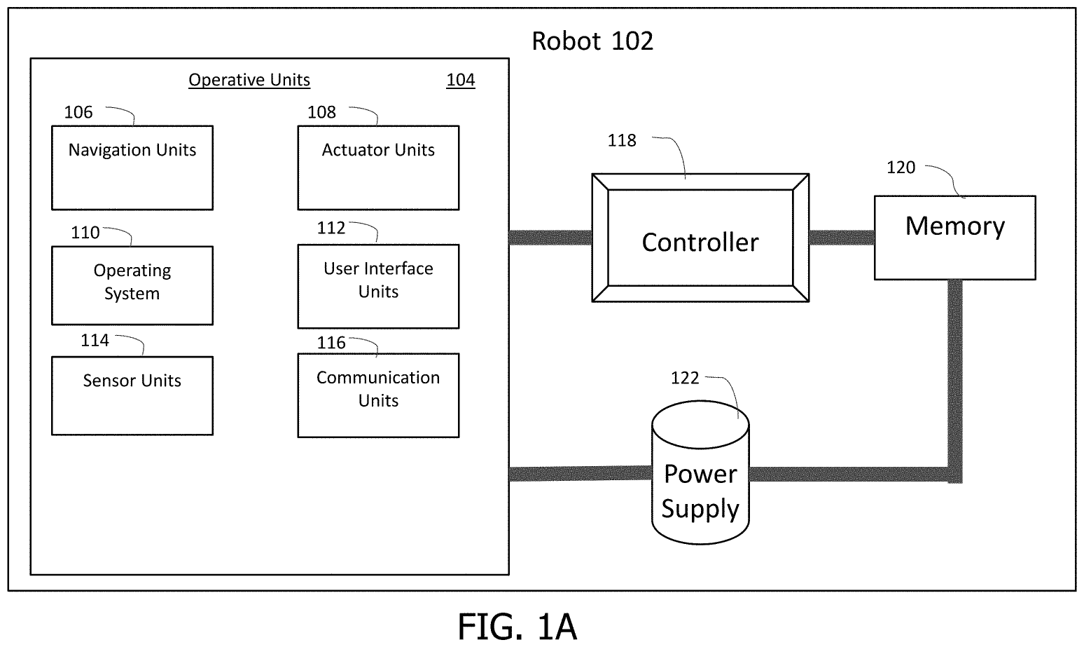

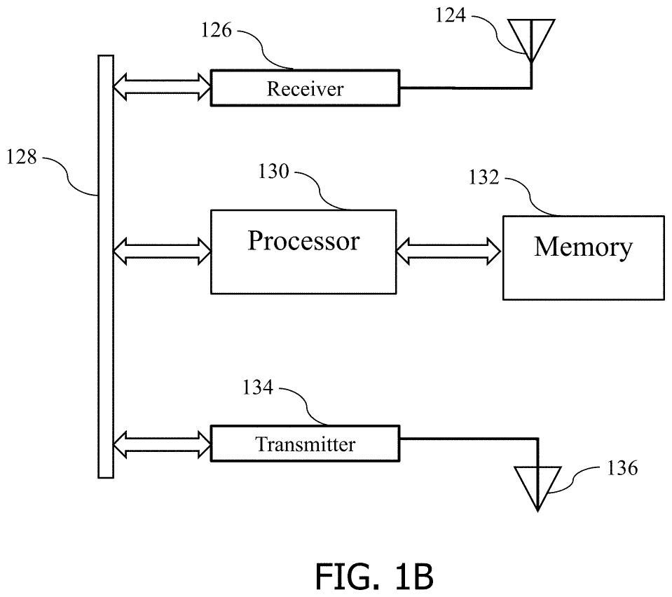

As used herein, a feature may comprise one or more numeric values (e.g., floating point, decimal, a tensor of values, etc.) characterizing an input from a sensor unit 114 of a robot 102, described in FIG. 1A below, including, but not limited to, detection of an object, parameters of the object (e.g., size, shape, color, orientation, edges, etc.), color values of pixels of an image, depth values of pixels of a depth image, brightness of an image, the image as a whole, changes of features over time (e.g., velocity, trajectory, etc. of an object), sounds, spectral energy of a spectrum bandwidth, motor feedback (i.e., encoder values), sensor values (e.g., gyroscope, accelerometer, GPS, magnetometer, etc. readings), a binary categorical variable, an enumerated type, a character/string, or any other characteristic of a sensory input. A training feature, as used herein, may comprise any feature of which a neural network is to be trained to identify or has been trained to identify within sensor data.

As used herein, a training pair, training set, or training input/output pair may comprise any pair of input data and output data used to train a neural network. Training pairs may comprise, for example, a red-green-blue (RGB) image and labels for the RGB image. Labels, as used herein, may comprise classifications or annotation of a pixel, region, or point of an image, point cloud, or other sensor data types, the classification corresponding to a feature that the pixel, region, or point represents (e.g., “car,” “human,” “cat,” “soda,” etc.). Labels may further comprise identification of a time dependent parameter or trend including metadata associated with the parameter, such as, for example, temperature fluctuations labeled as “temperature” with additional labels corresponding to a time when the temperature was measured (e.g., 3:00 pm, 4:00 pm, etc.), wherein labels of a time dependent parameter or trend may be utilized to train a neural network to predict future values of the parameter or trend.

As used herein, a model may represent any mathematical function characterizing an input to an output. Models may include a set of weights of nodes of a neural network, wherein the weights configure a mathematical function which relates an input at input nodes of the neural network to an output at output nodes of the neural network. Training a model is substantially similar to training a neural network as the model may be derived from the training of the neural network, wherein training of a model and training of a neural network, from which the model is derived, may be used interchangeably herein.

As used herein, an inference may comprise utilization of a model given an input to generate an output. Inferences may be generated by providing an input to a model, executing the model (i.e., calculating a result using a mathematical function), and determining an output. Robots and/or devices may perform inferences using a given input to a model by a processing device executing computer readable instructions from a memory.

As used herein, a robot or device comprising a model corresponds to the model being stored in a non-transitory computer readable memory of the robot or device. In some instances, the model may be communicated (e.g., via wired or wireless communications) to the robot prior to utilization of the model by the robot, as understood by one skilled in the art.

As used herein, an idle robot may comprise a robot which is not navigating a route, moving, or performing any tasks but is still, in part, activated (i.e., powered on). An idle robot may receive power from a power supply 122, illustrated in FIG. 1A below, and operate, for example, in a low-power mode. In some instances, an idle robot may refer to a robot comprising excess computing power. For example, a robot may utilize 50% of its processing resources (e.g., cores of a CPU/GPU, fetch/decode/execute cycles, etc.) to perform its tasks (e.g., navigate a route), wherein the robot may be considered, at least in part, as an idle robot. The robot may be considered idle as the remaining 50%, or any percentage greater than zero, of the processing resources may be utilized to perform other tasks designated by a cloud server, as described below.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processing device, microprocessor, and/or digital processing device may include any type of digital processing device such as, without limitation, digital signal processors (“DSPs”), reduced instruction set computers (“RISC”), general-purpose (“CISC”) procesor, microprocesor, gate arrays (e.g., field programmable gate arrays (“FPGAs”)), programmable logic device (“PLDs”), reconfigurable computer fabrics (“RCFs”), array processing devices, secure microprocessors, specialized processors (e.g., neuromorphic processors), and application-specific integrated circuits (“ASICs”). Such digital processing devices may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enhance autonomy of robots by enabling robots to utilize trained models for feature detection; (ii) improve task performance and/or task selection based on identified features; (iii) optimize communication bandwidth between robots and a cloud server; (iv) improve utility of a robot by enabling separate robots, comprising excess computing resources, to perform inferences based on models trained on a cloud server; and (v) reduce costs associated with training neural networks by utilizing robots for accurate, reliable, and repeatable data collection. Other advantages are readily discernable by one having ordinary skill in the art given the contents of the present disclosure.

According to at least one non-limiting exemplary embodiment, a method for training one or more neural networks to develop a model for use in enhancing functionality of one or more robots is disclosed. The method comprises receiving sensor data from one or more sensor units of one or more robots; receiving labels of the received sensor data, the labels comprising identified at least one training feature within the sensor data; utilizing the received sensor data and the labels to train the one or more neural networks to develop the model to identify the at least one training feature; and communicating the model to one or more robots upon the model achieving a training level above a threshold value. The training level corresponding to an accuracy of the model, the accuracy being based on a training process of the one or more neural networks. The method may further comprise receiving sensor data from one or more sensor units of a first robot; communicating the sensor data to a second robot, the second robot comprising the model trained to identify the at least one training feature; generating an inference by the second robot based on the model, the inference comprising detection, or lack thereof, of the at least one training feature within the sensor data; and communicating the inference to, at least, the first robot.

According to at least one non-limiting exemplary embodiment, the method may further comprise utilizing the model to identify one or more of the training features within sensor data acquired by a robot at a location; localize, or identify the location of, the robot at the location; and correlating the location of the robot with the training features observed at the location. The method may further comprise the robot utilizing the correlation between the location of the robot and the features observed to, during subsequent navigation at the location, determine if at least one of one or more of the training features are missing or one or more additional training features are detected at the location; and performing a task based on the training features, or lack thereof, detected at the location deviating from the training features detected at the location during prior navigation at the location, the detection of the training features being performed using the model. The task comprises at least one of the robots navigating a route, emitting a signal to alert a human or other robots of the change in the observed training features, or uploading sensor data captured at the location to a cloud or centralized server for use in enhancing the model.

According to at least one non-limiting exemplary embodiment, the method may further comprise receiving sensor data from a third robot; detecting none of the training features are present within the sensor data using the model; and receiving labels of the sensor data to further train the model to identify at least one additional feature, the further training of the model comprises training of at least one neural network to identify the at least one additional feature.

According to at least one non-limiting exemplary embodiment, the method may further comprise enhancing the model using additional training pairs, the training pairs comprising sensor data acquired by the one or more robots and labels generated for the sensor data subsequent to the communication of the model to the one or more robots; and communicating changes to the model based on the additional training pairs to the one or more robots which utilize the model.

According to at least one non-limiting exemplary embodiment, the method is effectuated by a cloud server. The cloud server may comprise a distributed network of controllers and processing devices executing computer readable instructions, the distributed network of controllers and processing devices being located on the one or more robots and devices coupled to the cloud server. The model is representative of learned weights of the one or more neural networks, the one or more neural networks being trained using labels of the sensor data in accordance with a training process.

According to at least one non-limiting exemplary embodiment, a method for training a model and communicating the model to a robot to enhance functionality of the robot is disclosed. The method may comprise training of one or more neural networks using sensor data acquired by one or more robots. The sensor data may be provided to an annotator configurable to label the sensor data such that the sensor data in conjunction with the labels may be utilized to train one or more neural networks 300 to identify one or more training features within the sensor data. The method may further comprise communicating the model derived from the one or more neural networks to one or more robots. The model being based on learned weights of the one or more neural networks, the weights being learned using the sensor data and labels thereto. The method being effectuated by a cloud server comprising a distributed network of processing devices and controllers on robots and devices coupled to the cloud server.

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessors) and other peripherals. As previously mentioned and used herein, processing device, microprocessor, and/or digital processing device may include any type of digital processing device such as, without limitation, digital signal processors (“DSPs”), reduced instruction set computers (“RISC”), complex instruction set computer (“CISC”) processors, microprocessors, gate arrays (e.g., field programmable gate arrays (“FPGAs”)), programmable logic device (“PLDs”), reconfigurable computer fabrics (“RCFs”), array processing devices, secure microprocessors, specialized processors (e.g., neuromorphic processors), and application-specific integrated circuits (“ASICs”). Such digital processing devices may be contained on a single unitary integrated circuit die, or distributed across multiple components.

Controller 118 may be operatively and/or communicatively coupled to memory 120. Memory 120 may include any type of integrated circuit or other storage device configurable to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configurable to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configurable to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configurable to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, receive/send interrogatory signals, receive and/or send statuses, and/or perform any operations for running features of robot 102.

Returning to FIG. 1A, operative units 104 may include various units that perform one or more functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardware components of robot 102. In exemplary embodiments, units of operative units 104 may comprise both computer-implemented instructions executed by a controller and hardware components. Where operative units 104 are implemented in part in software, operative units 104 may include units/modules of code configurable to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configurable to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may include actuating the wheels for robot 102 to navigate a route; navigate around obstacles; rotate cameras and sensors.

Actuator unit 108 may include any system used for actuating, in some cases to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction including up or down?). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external to robot 102. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor or sensing device known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Measurement data from the sensor units 114 may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configurable to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, user interface units 112 may be configurable to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”), miniSD, microSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, ultra high definition (“UHD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configurable to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configurable to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configurable to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configurable to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configurable to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used here on out, a robot 102, a controller 118, or any other controller, processing device, or robot performing a task illustrated in the figures below comprises a controller executing computer readable instructions stored on a non-transitory computer readable storage apparatus, such as memory 120, as would be appreciated by one skilled in the art.

Next referring to FIG. 1B, the architecture of the specialized controller 118 used in the system shown in FIG. 1A is illustrated according to an exemplary embodiment. As illustrated in FIG. 1B, the specialized computer includes a data bus 128, a receiver 126, a transmitter 134, at least one processing device 130, and a memory 132. The receiver 126, the processing device 130 and the transmitter 134 all communicate with each other via the data bus 128. The processing device 130 is a specialized processing device configurable to execute specialized algorithms. The processing device 130 is configurable to access the memory 132 which stores computer code or instructions in order for the processing device 130 to execute the specialized algorithms. As illustrated in FIG. 1B, memory 132 may comprise some, none, different, or all of the features of memory 120 previously illustrated in FIG. 1A. The algorithms executed by the processing device 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal(s) from an operative unit 104 requiring further processing by the specialized controller 118. The receiver 126 communicates these received signals to the processing device 130 via the data bus 128. As one skilled in the art would appreciate, the data bus 128 is the means of communication between the different components—receiver, processing device, and transmitter—in the specialized controller 118. The processing device 130 executes the algorithms, as discussed below, by accessing specialized computer-readable instructions from the memory 132. Further detailed description as to the processing device 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processing device 130 may communicate output signals to transmitter 134 via data bus 128 as illustrated. The transmitter 134 may be configurable to further communicate the output signals to a plurality of operative units 104 illustrated by signal output 136.

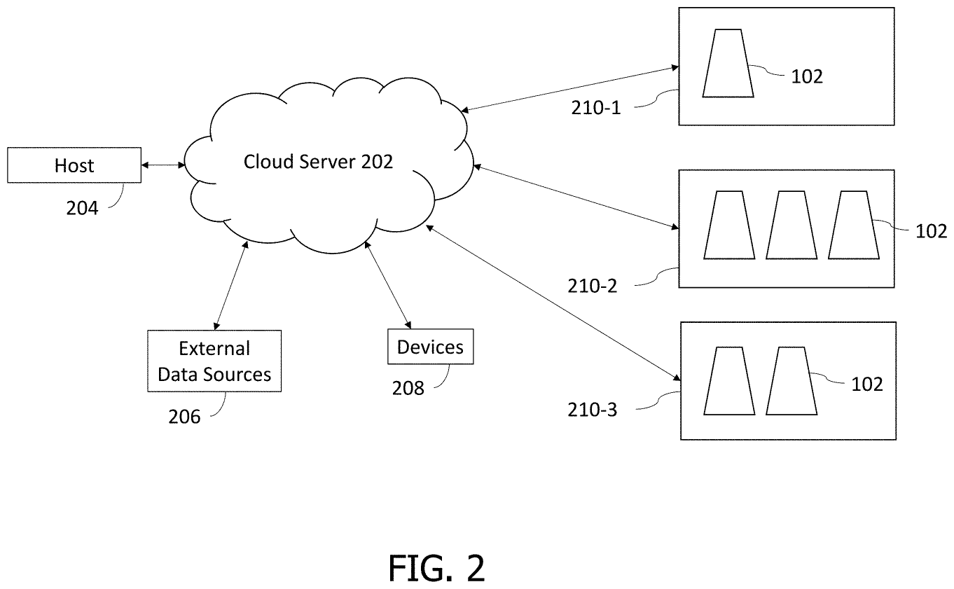

One of ordinary skill in the art would appreciate that the architecture illustrated in FIG. 1B may illustrate an external server architecture configurable to effectuate the control of a robotic apparatus [just robot?] from a remote location, such as a cloud server 202 illustrated next in FIG. 2. That is, the server may also include a data bus, a receiver, a transmitter, a processing device, and a memory that stores specialized computer readable instructions thereon.

FIG. 2 illustrates a cloud server 202 and communicatively coupled components thereof in accordance with some exemplary embodiments of this disclosure. The cloud server 202 may comprise one or more processing units depicted in FIG. 1B above, each processing unit comprising at least one processing device 130 and memory 132 therein in addition to, without limitation, any other components illustrated in FIG. 1B. Communication links between the cloud server 202 and coupled devices may comprise wireless and/or wired communications, wherein the cloud server 202 may further comprise one or more coupled antenna, transmitters, and/or receivers to effectuate the wireless communication. The cloud server 202 may be coupled to a host 204, wherein the host 204 may correspond to a high-level entity (e.g., an admin or owner) of the cloud server 202. The host 204 may, for example, upload software and/or firmware updates for the cloud server 202 and/or coupled devices 208 and 210. The host 204 may couple or decouple data sources 206, devices 208, and/or robots 102 of robot networks 210 to/from the cloud server 202. In some embodiments, host 204 may be illustrative of multiple entities or access points from which the updates, coupling/decoupling of devices, and/or any other high-level (i.e., administrative) operations may be performed. External data sources 206 may comprise any publicly available data sources (e.g., public databases such as weather data from the national oceanic and atmospheric administration (NOAA), satellite topology data, public records, etc.) and/or any other databases (e.g., private databases with paid or restricted access) of which the cloud server 202 may access data therein. Edge devices 208 may comprise any device configurable to perform a task at an edge of the cloud server 202. These devices may include, without limitation, internet of things (IoT) devices (e.g., stationary CCTV cameras, smart locks, smart thermostats, etc.), external processing devices (e.g., external CPUs or GPUs), and/or external memories configurable to receive and execute a sequence of computer readable instructions, which may be provided at least in part by the cloud server 202, and/or store large amounts of data.

Lastly, the cloud server 202 may be coupled to a plurality of robot networks 210, each robot network 210 comprising a network of at least one robot 102. Each separate network 210 may comprise one or more robots 102 operating within separate environments from each other. An environment may comprise, for example, a section of a building (e.g., a floor or room) or any space in which the robots 102 operate. Each robot network 210 may comprise a different number of robots 102 and/or may comprise different types of robot 102. For example, network 210-2 may comprise a scrubber robot 102, vacuum robot 102, and a gripper arm robot 102, whereas network 210-1 may only comprise a robotic wheelchair, wherein network 210-2 may operate within a retail store while network 210-1 may operate in a home of an owner of the robotic wheelchair or a hospital. In some embodiments, each robot network 210 may comprise a same type of robot (e.g., network 210-1 comprises cleaning robots, network 210-2 comprises robotic wheelchairs, and so forth). That is, robot networks 210 may comprise any grouping of robots 102 by, for example, type of robot 102 or environment in which the robot(s) of networks 210 operate. In some embodiments, a single robot 102 may belong to two or more networks 210 (e.g., a cleaning robot 102 may belong to a “cleaning robot” network 210 and a “grocery store” network 210). In some embodiments, each robot 102 may be individually linked to the cloud server 202 independently from other robots 102. Robots 102 of robot networks 210 may communicate data including, but not limited to, sensor data (e.g., RGB images captured, LiDAR scan point clouds, network signal strength data from sensors 202, etc.), IMU data, navigation and route data (e.g., which routes were navigated), localization data of objects within each respective environment, and metadata associated with the sensor, IMU, navigation, and localization data. Each robot 102 within each network 210 may receive communication from the cloud server 202 including, but not limited to, a command to navigate to a specified area, a command to perform a specified task, a request to collect a specified set of data using one or more sensor units 114, a sequence of computer readable instructions to be executed on respective controllers 118 of the robots 102, software updates, and/or firmware updates. In some embodiments, individual robots 102 may receive direct communication from the cloud server 202 rather than the network 210 as a whole. One skilled in the art may appreciate that a cloud server 202 may be further coupled to additional relays and/or routers to effectuate communication between the host 204, external data sources 206, edge devices 208, and robots 102 of networks 210 which have been omitted for clarity. It is further appreciated that a cloud server 202 may not exist as a single hardware entity, rather may be illustrative of a distributed network of non-transitory memories and processing devices, the processing devices being comprised within, at least in part, the robots 102 and the devices 208.

One skilled in the art may appreciate that any determination or calculation described herein performed by a cloud server 202 may comprise one or more processing devices of the cloud server 202, edge devices 208, and/or robots 102 of networks 210 performing the determination or calculation by executing computer readable instructions. The instructions may be executed by a processing device of the cloud server 202 and/or may be communicated to robot networks 210 and/or edge devices 208 for execution on their respective controllers/processing devices in part or in entirety. That is, the coupled devices 208 and robots 102 of robot networks 210 may form a distributed network of processing devices. Advantageously, use of a cloud server 202 comprising a distributed network of processing devices may enhance a speed at which parameters may be measured, analyzed, and/or calculated by executing the calculations (i.e., computer readable instructions) on the distributed network of processing devices of robots 102 and edge devices 208. This may be analogous to utilizing a plurality of processing devices executing instructions in parallel, thereby enhancing a rate at which the instructions may be executed. Further, use of the distributed network of controllers 118 of robots 102 may further enhance functionality of the robots 102 as the robots 102 may execute instructions on their respective controllers 118 during times when the robots 102 are not operating (i.e., when robots 102 are idle), wherein cloud server 202 may distribute/communicate, at least in part, instructions to one or more idle robots 102 to further enhance utility of the one or more robots 102 by optimizing or maximizing computing resource usage.

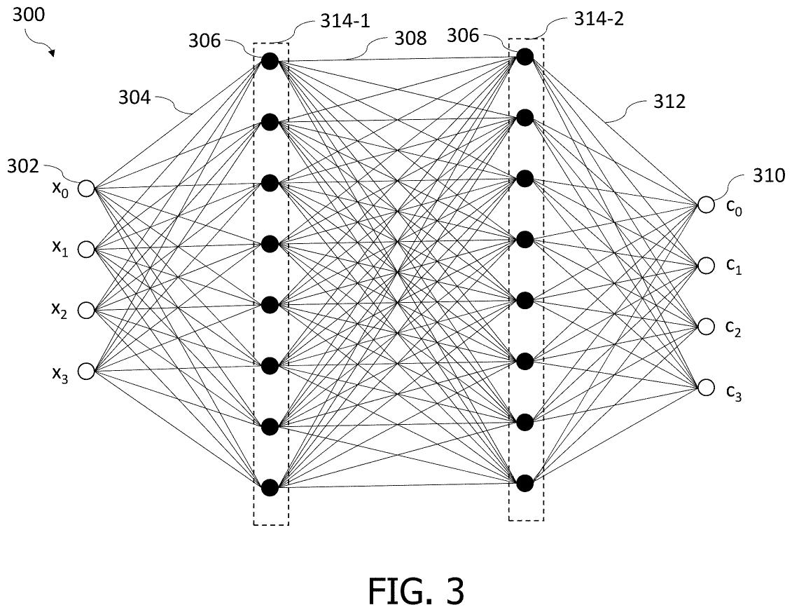

FIG. 3 illustrates a neural network 300, according to an exemplary embodiment. The neural network 300 may comprise a plurality of input nodes 302, intermediate nodes 306, and output nodes 310. The input nodes 302 being connected via links 304 to one or more intermediate nodes 306. Some intermediate nodes 306 are respectively connected, in part, via links 308 to one or more adjacent intermediate nodes 306. Some intermediate nodes 306 are connected, in part, via links 312 to output nodes 310. Links 304, 308, 312 illustrate inputs/outputs to/from the nodes 302, 306, and 310 in accordance with equation 1 below. The intermediate nodes 306 may form an intermediate layer 312 of the neural network 300. In some embodiments, a neural network 300 may comprise a plurality of intermediate layers 312, intermediate nodes 306 of each intermediate layer 312 being linked to one or more intermediate nodes 306 of adjacent intermediate layers 314, unless an adjacent layer is an input layer (i.e., input nodes 302) or an output layer (i.e., output nodes 310). The two intermediate layers 312 illustrated may correspond to a hidden layer of neural network 300. Each node 302, 306, and 310 may be linked to any number of input, output, or intermediate nodes, wherein linking of the nodes as illustrated is not intended to be limiting.

The input nodes 306 may receive a numeric value xᵢ representative of, at least in part, a feature, i being an integer index. For example, xᵢ may represent color values of an i^{th} pixel of a color image. The input nodes 306 may output the numeric value xᵢ to one or more intermediate nodes 306 via links 304. Each intermediate node 306 of a first (leftmost) intermediate layer 314-1 may be configurable to receive one or more numeric values xᵢ from input nodes 302 via links 302 and output a value k to links 308 following equation 1 below:

k_{i,j}=a_{i,j}x₀+b_{i,j}x₁+c_{i,j}x₂+d_{i,j}x₃ (Eqn. 1)

Index i corresponds to a node number within a layer (e.g., x₁ denotes the first input node 302 of the input layer, indexing from zero). Index j corresponds to a layer, wherein j would be equal to one (1) for the leftmost intermediate layer 312-1 of the neural network 300 illustrated and zero (0) for the input layer of input nodes 302. Numeric values a, b, c, and d represent weights to be learned in accordance with a training process described below. The number of numeric values of equation 1 may depend on a number of input links 304 to a respective intermediate node 306 of the first (leftmost) intermediate layer 314-1. In this embodiment, all intermediate nodes 306 are linked to all input nodes 302, however this is not intended to be limiting.

Intermediate nodes 306 of the second (rightmost) intermediate layer 314-2 may output values k_{i,2} to respective links 312 following equation 1 above, wherein values xᵢ of equation 1 for the intermediate nodes 306 of the second intermediate layer 314-2 correspond to numeric values of links 308 (i.e., outputs of intermediate nodes 306 of layer 314-1). The numeric values of links 308 correspond to k_{i,1} values of intermediate nodes 306 of the first intermediate layer 314-1 following equation 1 above. It is appreciated that constants a, b, c, d may be of different values for each intermediate node 306 of the neural network 300. One skilled in the art may appreciate that a neural network 300 may comprise of additional/fewer intermediate layers 314; nodes 302, 306, 310; and/or links 304, 308, 312 without limitation.

Output nodes 310 may be configurable to receive at least one numeric value k_{i,j} from at least an i^{th} intermediate node 306 of a final (i.e., rightmost) intermediate layer 312. As illustrated, for example without limitation, each output node 310 receives numeric values k_{0-7,2} from the eight intermediate nodes 306 of the second intermediate layer 312-2. The output cᵢ of the output nodes 310 may be calculated following a substantially similar equation as equation 1 above (i.e., based on learned weights and inputs from connections 312). Following the above example where inputs xᵢ comprise pixel color values of an RGB image, the output nodes 310 may output a classification cᵢ of each input pixel (e.g., pixel i is a car, train, dog, person, background, soap, or any other classification of features). Outputs cᵢ of the neural network 300 may comprise any numeric values such as, for example, a softmax output, a predetermined classification scheme (e.g., cᵢ=1 corresponds to car, cᵢ=2 corresponds to tree, and so forth), a histogram of values, a predicted value of a parameter, and/or any other numeric value(s).

The training process comprises providing the neural network 300 with both input and output pairs of values to the input nodes 302 and output nodes 310, respectively, such that weights of the intermediate nodes 306 may be determined. The determined weights configure the neural network 300 to receive the input at the input nodes 302 and determine a correct output at the output nodes 310. By way of an illustrative example, labeled images may be utilized to train a neural network 300 to identify objects within the image based on annotations of the labeled images. The labeled images (i.e., the pixel RGB color values of the image) may be provided to input nodes 302 and the annotations of the labeled image (i.e., classifications for each pixel) may be provided to the output nodes 310, wherein weights of the intermediate nodes 306 may be adjusted such that the neural network 300 generates the annotations of the labeled images at the output nodes 310 based on the provided pixel color values to the input nodes 302. This process may be repeated using a substantial number of labeled images (e.g., hundreds or more) such that ideal weights of each intermediate node 306 may be determined.

Neural network 300 may be configurable to receive any set of numeric values (e.g., sensor data representing a feature) and provide an output set of numeric values (e.g., detection, identification, and/or localization of the feature within the sensor data) in accordance with a training process. For example, the inputs may comprise color values of a color image and outputs may comprise classifications for each pixel of the image. As another example, inputs may comprise numeric values for a time dependent trend of a parameter (e.g., temperature fluctuations within a building measured by a sensor) and output nodes 310 may provide a predicted value for the parameter at a future time based on the observed trends, wherein measurements of the trends of the parameter measured in the past may be utilized to train the neural network 300 to predict the trends in the future. Training of the neural network 300 may comprise providing the neural network 300 with a sufficiently large number of training input/output pairs, or training data, comprising ground truth (i.e., highly accurate) training data such that optimal weights of intermediate nodes 306 may be learned.

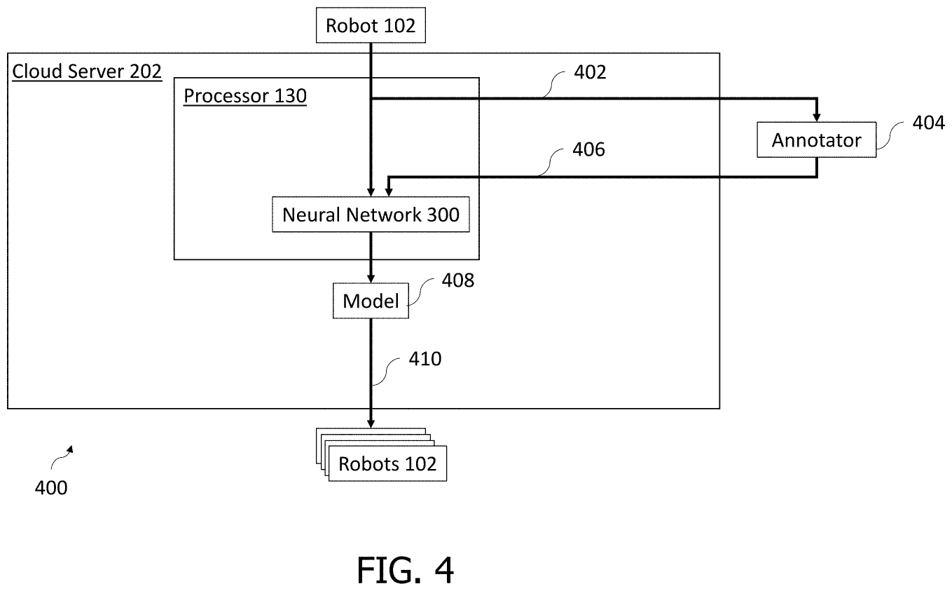

As used herein, a model (e.g., 408 illustrated in FIG. 4 below) derived from a neural network 300 may comprise of the weights of intermediate nodes 306 and output nodes 310 learned during the training process which configures a given input to an output. The model may be analogous to a mathematical function representing a relation between inputs and outputs of a neural network 300 based on the weights of intermediate nodes 306 (and output nodes 310, in some embodiments), wherein the values of the weights are learned during the training process. One skilled in the art may appreciate that utilizing a model from a well-trained neural network 300 to perform a function (e.g., identify a feature within sensor data from a robot 102) utilizes significantly less computational recourses than training of the neural network 300. Stated differently, training a neural network 300 is similar to determining a mathematical function to represent an input/output relationship, whereas utilizing the model is similar to utilizing a predetermined mathematical function for a given an input to generate an output.

According to at least one non-limiting exemplary embodiment, one or more outputs k_{i,j} from intermediate nodes 306 of a j^{th} intermediate layer 312 may be utilized as inputs to one or more intermediate nodes 306 an m^{th} intermediate layer 312, wherein index m may be greater than or less than j (e.g., a recurrent or feed forward neural network). According to at least one non-limiting exemplary embodiment, a neural network 300 may comprise N dimensions for an N dimensional feature (e.g., a 3 dimensional input image), wherein only one dimension has been illustrated for clarity. One skilled in the art may appreciate a plurality of other embodiments of a neural network 300, wherein the neural network 300 illustrated represents a simplified embodiment of a neural network and variants thereof and is not intended to be limiting.

One skilled in the art may appreciate that the neural network 300 illustrated represents a simplified embodiment of a neural network illustrating, at a high level, features and functionality thereof. Other embodiments of neural networks are considered without limitation, such as recurrent neural networks (RNN), long/short term memory (LSTM), deep convolutional networks (DCN), deconvolutional networks, auto encoders, image cascade networks (IC Net), and the like. Further, equation 1 is intended to represent broadly a method for each intermediate node 306 to determine its respective output, wherein equation 1 is not intended to be limiting as a plurality of contemporary neural network configurations utilize a plurality of similar methods of computing outputs, as appreciated by one skilled in the art. A neural network 300 may be realized in hardware (e.g., neuromorphic processing devices), software (e.g., computer code on a GPU/CPU), or a combination thereof.

FIG. 4 is a functional block diagram illustrating a system 400 configurable to train a neural network 300 and communicate a model 408 to one or more robots 102 to enhance functionality of the one or more robots 102, according to an exemplary embodiment. As used herein, enhancing functionality of a robot 102 may comprise improving at least one of feature identification, navigation, task selection, task performance, reduction of assistance from human operators, autonomy of the robot 102 as a whole, and/or expanding use of robots 102 beyond their baseline functionality (e.g., using a cleaning robot 102 for purposes other than cleaning).

Cloud server 202, illustrated in FIG. 2 above, may receive communications 402 from a robot 102 communicatively coupled to the cloud server 202. Communications 402 may comprise sensor data collected using sensor units 114 of the robot 102. The sensor data may further comprise localization metadata associated thereto corresponding to a location of the robot 102 during acquisition of the sensor data; the localization being performed by a controller 118 of the robot 102. The sensor data may further comprise other metadata such as time stamps. The sensor data may comprise, at least in part, one or more training features represented therein, the training features being features of which the neural network 300 is to be trained to identify within sensor data collected by the robot 102. Processing device 130 of the server 202 may execute computer readable instructions from a memory 132 (illustrated in FIG. 1B above) to send the sensor data to an annotator 404. Annotator 404 may be external to the server 202 as illustrated and may be illustrative of an annotation company (e.g., ThingLink, Imgga, Figure Eight, etc.) or other human or computerized entity which labels the received sensor data from communications 402. Annotator 404 may comprise one or more annotation companies, humans, or computerized entities and is not intended to be limited to a single entity.

According to at least one non-limiting exemplary embodiment, cloud server 202 may receive communications 402, comprising sensor data, from a plurality of robots 102. That is, receiving sensor data from a single robot 102 for use in training a neural network 300 is not intended to be limiting.

Annotator 404 may receive the communications 402, comprising sensor data such as RGB images, point clouds, measurements of time dependent parameters, etc., and provide labels of the sensor data for use in training a neural network 300. The labels identify one or more of the training features within the sensor data. The training features corresponding to one or more features of which a neural network 300 is to be trained to identify (e.g., a “car,” “cat,” “cereal,” etc.). Stated differently, the annotator 404 receives sensor data and provides labels or annotations for the sensor data for use in training a neural network 300 to identify one or more of the training features. It is appreciated that all of the training features may not be present in every input of sensor data from a robot 102 (e.g., every image uploaded may only comprise some of the training features captured therein). The sensor data is to be utilized as inputs to input nodes 302 of a neural network 300 and the annotations are to be utilized as outputs of output nodes 310 of the neural network 300 in accordance with a training process described in FIG. 3 above.

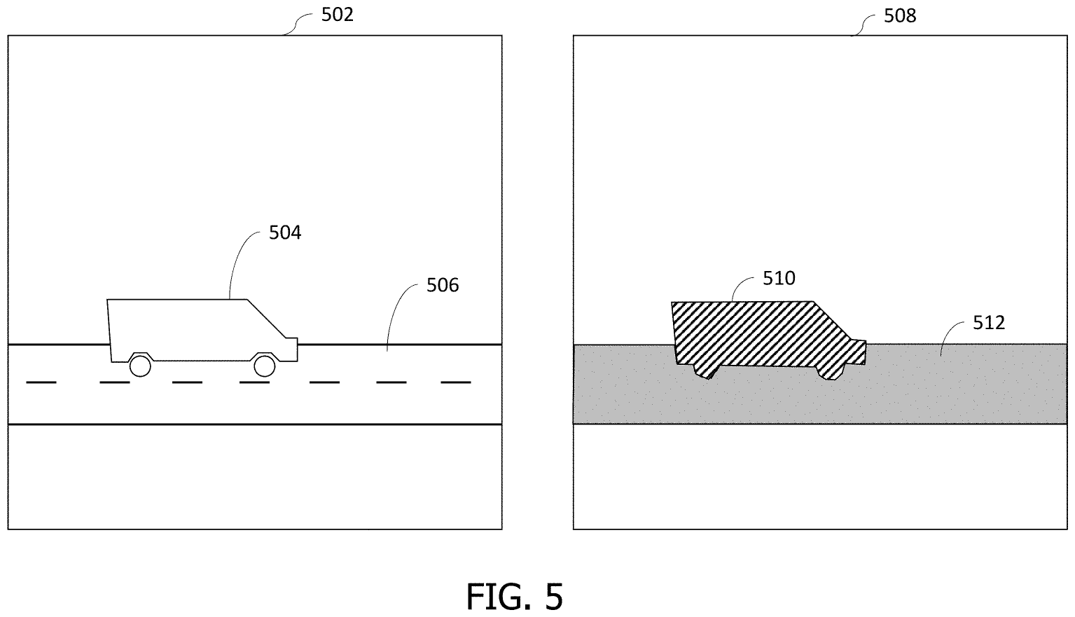

By way of illustrative example, with reference to FIG. 5 which illustrates an exemplary first image 502, comprising an RGB image of a car 504 on a road 506, and labels associated thereto represented by a second image 508, according to an exemplary embodiment. Pixels of the car 504 of the first image 502 may be labeled using annotations 510 (dashed lines) comprising a “car” classification, or similar classification (e.g., “vehicle” and the like). Pixels of the road 506 are labeled using annotations 512 (grey) comprising a “road” classification, or similar classification. The remaining pixels (white) may be labeled with a “background” classification or other default classification. Accordingly, “car” and “road” may be considered training features if image 502 and annotations 508 are provided to input nodes 302 and output nodes 310, respectively, of a neural network 300 in accordance with a training process. It is appreciated that the second image 508 comprising annotation data for pixels of the first image 502 may be a visual representation of encoded labels and may or may not exist as a visual image in every embodiment. It is additionally appreciated that identification of training features 510, 512 within RGB images is intended to be illustrative and non-limiting, wherein a neural network 300 may identify features in any form of sensor data, provided an annotator 404 is configurable to generate training data (i.e., annotations or labels). For example, annotation data for a point cloud may correspond to annotating one or more points or 3-dimensional regions with a classification of a training feature (e.g., “car”).

According to at least one non-limiting exemplary embodiment, labels of an image 502 may comprise bounding boxes around features (e.g., 504 and 506) instead of encoded pixels. That is, annotations are not intended to be limited to classifications of individual pixels. In these embodiments, labels may further comprise a classification (e.g., “car,” “chips,” etc.) and parameters of an associated bounding box including, without limitation, a position of one or more vertices of the bounding box and size of the bounding box (e.g., height and width). In some embodiments, the bounding box may comprise a continuous or discrete function representative of an area, such as, for example, a hexagon or other shape (e.g., shape of car 504) occupied by a training feature within an image 502.

According to at least one non-limiting exemplary embodiment, a pixel of image 502 may comprise two or more labels associated thereto. For example, a pixel may comprise both a “car” label and a “wheel” label if the pixel is a wheel of the car 504.

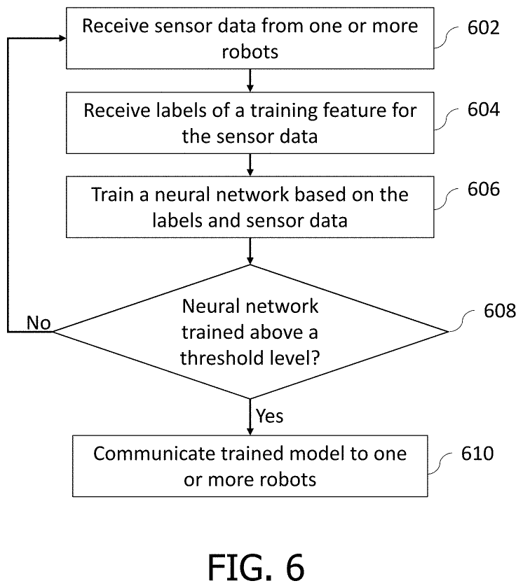

Returning now to FIG. 4, communications 406 comprises labels for the input sensor data of communications 402 (e.g., annotations 510, 512 of image 508 of FIG. 5). The communications 402 and 406 may be utilized as training inputs and outputs, respectively, for training of a neural network 300. The neural network 300 being trained to identify the training features (i.e., features labeled by annotator 404) of the input sensor data. Processing device 130, or separate processing device (e.g., external GPU, controller 118 on one or more distributed robots 102 and/or devices 208, etc.), may perform the training (i.e., adjusting of weights of equation 1 above) based on the input sensor data and labels of the input sensor data. In other words, the weights of the neural network 300 are configured such that the input sensor data, from communications 402, generates correct identification of the training features represented therein, the training features being identified from communications 406. Upon the neural network 300 reaching a sufficient training level, as discussed further below in FIG. 6, a model 408 may be extracted from the neural network 300 based on the weights of individual intermediate nodes 306 (and output nodes 310, in some embodiments) of the neural network 300 determined in accordance with the training process. The model 408 may comprise a mathematical function configurable to receive numeric values of input sensor data (e.g., inputs xᵢ of FIG. 3 such as RGB color values of pixels of an image) and output numeric values corresponding to identification of training features (e.g., outputs cᵢ comprising classification of a respective input pixel xᵢ). The model 408 may be communicated to one or more robots 102 via communications 410.

It is appreciated that communications 402, 406, 410 may comprise wired and/or wireless communications and may further be effectuated by routers, relays, and/or other hardware (e.g., transmission lines) and/or software elements well known within the art and omitted for clarity.

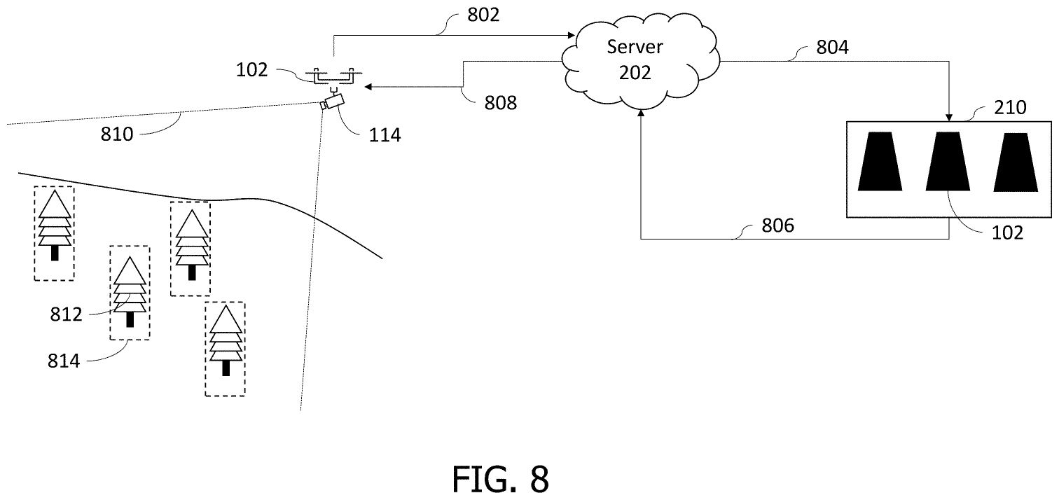

Advantageously, each robot 102 which receives communications 410 may now comprise a trained model 408 stored in respective memories 120 which the robots 102 may utilize to identify the training features during operation. For example, communications 406 may comprise annotations, or labels for portions of RGB images, comprising images of puddles of liquid, the RGB images being communicated to the annotator 404 via communications 402. Annotator 404 may identify and annotate (i.e., encode, label, etc.) pixels representing puddles of liquid within the RGB images from the communications 402, wherein both the RGB images and annotations of the RGB images may be utilized to train a neural network 300 to identify puddles within RGB images. Thereby, training a model 408 configurable to receive an RGB image and identify puddles of liquid within the RGB image if a puddle of liquid is represented therein. Running this puddle identification model 408 on one or more robots 102 may enable the one or more robots 102 to identify puddles during operation and plan their movements accordingly. For example, a cleaning robot 102 may clean identified puddles while other robots 102 may avoid puddles as a safety measure. Advantageously, the system 400 enables robots 102 to be trained to identify training features using a model 408, the model 408 being trained externally to the robots 102 thereby reducing computational load imposed on the robots 102 to generate and train their own respective models 408. As stated above, training of a model 408 utilizes significantly more computational resources than utilization of a pretrained model 408. Further, processing device 130 may be illustrative of a distributed network of processing devices on a plurality of robots 102 and/or devices 208, wherein training of the model 408 may be performed on processing devices/controllers of robots 102 and/or devices 208 with extra bandwidth or unused computing resources (e.g., idle robots 102), as illustrated in FIG. 8 below.

According to at least one non-limiting exemplary embodiment, processing device 130 may be illustrative of a distributed network of processing devices and controllers of robots 102 and/or devices 208. That is, robots 102 coupled to the server 202 may utilize their respective controllers 118 to train the neural network 300, wherein training of the neural network 300 on the server 202 separate from the robots 102 is not intended to be limiting.

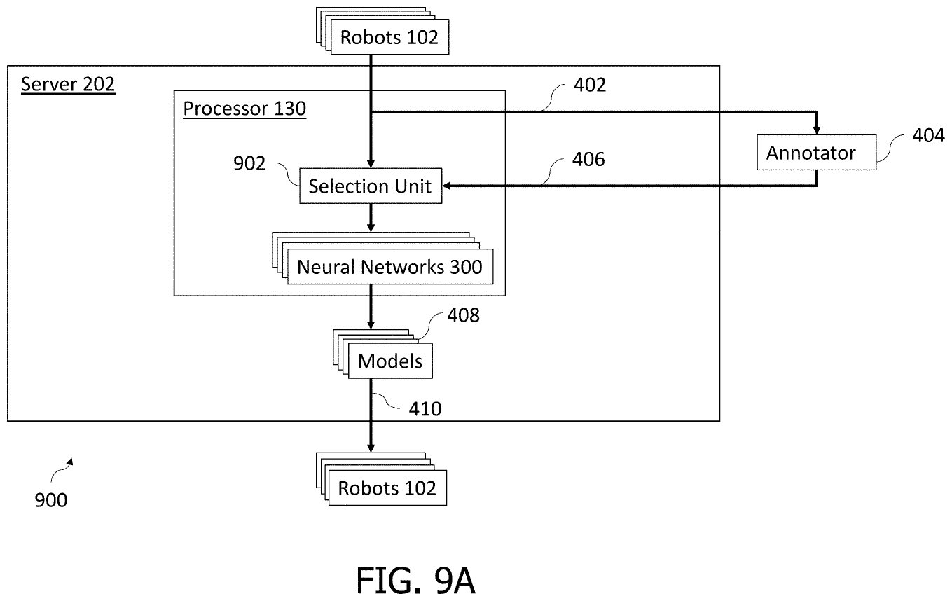

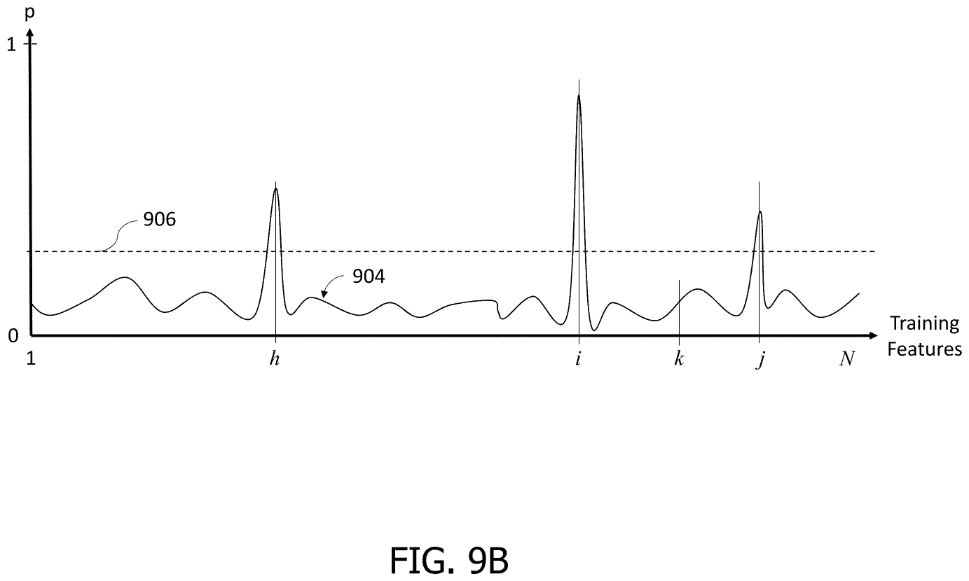

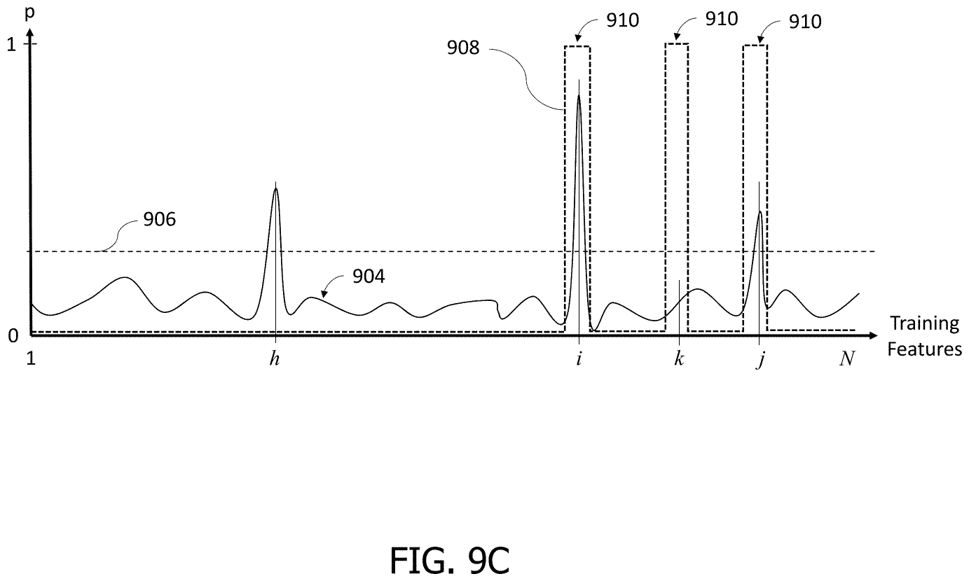

FIG. 6 is a process flow diagram illustrating a method 600 for a processing device 130, or distributed network of processing devices, of a cloud server 202, comprising at least in part a system 400 of FIG. 4 above, to generate a trained model 408 for use by one or more robots 102 to identify training features within sensor data, according to an exemplary embodiment. It is appreciated that any steps of method 600 performed by the processing device 130 and/or the cloud server 202 corresponds to one or more processing devices of a distributed network of processing devices and controllers 118 on devices 208 and/or robots 102 executing computer readable instructions from a non-transitory memory. In some embodiments, the computer readable instructions executed on individual processing devices of the distributed network may be communicated to the respective processing devices by the cloud server 202. Method 600 illustrates a method for training a single neural network 300 to identify a single training feature for clarity, wherein one skilled in the art may expand upon method 600 to train multiple neural networks 300 to identify multiple training features, as illustrated below in FIG. 9.

Block 602 illustrates the processing device 130 receiving sensor data from one or more robots 102. The sensor data may comprise, at least in part, a training feature represented therein. The sensor data may be acquired by one or more sensor units 114 illustrated in FIG. 1A above and communicated to the processing device 130 of the cloud server 202 using communications units 116 of the one or more robots 102. The training feature, as used herein, being any feature of which the model 408, derived from a trained neural network 300, is to be trained to identify within sensor data acquired by a robot 102. The sensor data may be communicated to the cloud server 202 via communications 402, communications 402 comprising a wired and/or wireless communication channel. The sensor data may comprise, for example, RGB images, a video stream, LiDAR point clouds, and/or any other data type which may represent, at least in part, the training feature.

Block 604 illustrates the processing device 130 receiving labels of the training feature within the sensor data. The labels being received from an annotator 404, illustrated in FIG. 4 above. The labels comprising identified pixels and/or regions which represent the training feature within the sensor data. For example, the sensor data received in block 602 may comprise an RGB image 502 illustrated in FIG. 5, wherein the training feature may comprise car 504. Accordingly, the labels of the sensor data may comprise classification of pixels or regions representing the car 504 annotated with a “car” or similar classification, wherein “car” is the training feature. Other classifications are considered without limitation, wherein use of car 504 is not intended to be limiting.

Block 606 illustrates the processing device 130 training the neural network 300 based on the sensor data, received in block 602, and labels of the sensor data, received in block 604. Training of the neural network 300, with reference to FIG. 3 above, comprises of providing the sensor data to input nodes 302 and labels of the sensor data to output nodes 310 and configuring weights of intermediate nodes 306, in accordance with equation 1 above, to produce the labels given the input sensor data.

For example, the input sensor data may comprise image 502 of FIG. 5, wherein each input node 302 may receive an input color value xᵢ comprising an 8, 16, 32, etc. bit color value for each pixel of the image. The output classifications cᵢ of each pixel (e.g., as “car,” “road,” or background) follows a predetermined numeric classification scheme (e.g., a value of 1 for car, 2 for road and 0 for background). Alternatively, the classifications at the output nodes 310 may follow a histogram of probabilities, as illustrated in FIG. 9B-C below. Weights of each intermediate node 306 (e.g., constants a, b, c, d, etc. of equation 1) may therefore be determined such that the provided input xᵢ to the input nodes 302 (i.e., the sensor data) yields the corresponding provided output cᵢ at the output nodes 310 (i.e., the labels, or annotations, of the sensor data). These learned weights which relate the inputs at the input nodes 302 to outputs at the output nodes 310, as used herein, comprise a model 408.

Block 608 illustrates the processing device determining if the neural network 300 is trained above a threshold level. The threshold level may correspond to the neural network 300 achieving a correctness rating above a predetermined value. The correctness rating being proportional to a number of correct annotations generated using the model 408 (e.g., a percentage of correctly classified pixels within an image). For example, processing device 130 may provide the neural network 300 with an input RGB image such that an output at output nodes 310 is produced, the output comprising classifications of each pixel or regions of pixels within the input image. The output classifications for each pixel may be compared to labels received from an annotator 404 as a method of measuring correctness rating of the neural network 300, wherein the correctness rating may correspond to a percentage of correctly predicted labels of pixels by the neural network 300 using the labels from the annotator 404 as a reference (i.e., ground truth). A predicted label for an image comprises a label generated by the neural network 300 for the image. In other words, the training above the threshold level corresponds to the neural network 300 being configured (i.e., trained) to identify one or more training features with an accuracy above a threshold value, wherein the accuracy of the neural network 300 may be verified in a plurality of ways without limitation as appreciated by one skilled in the art.

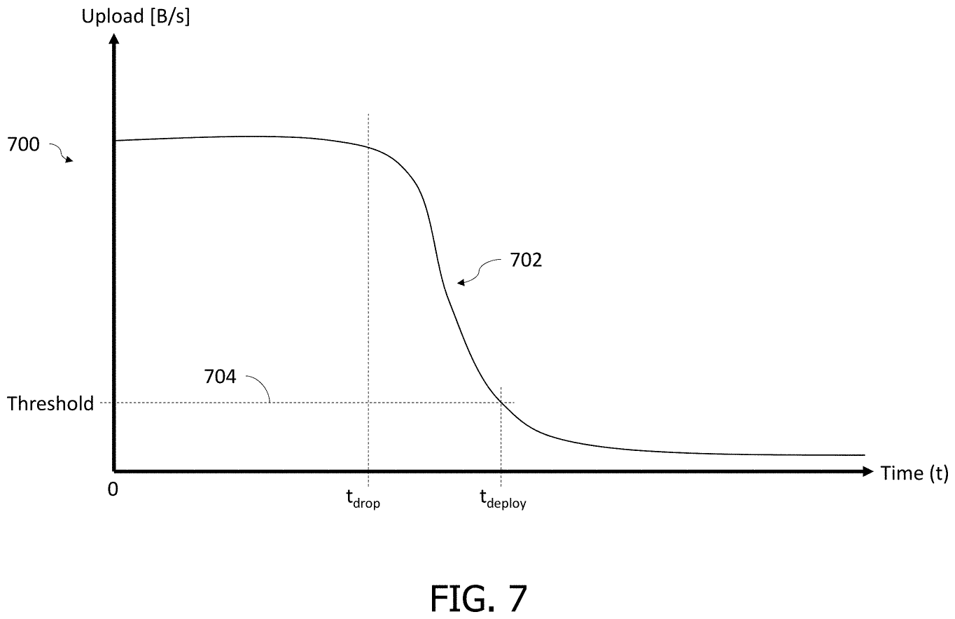

According to at least one non-limiting exemplary embodiment, the one or more robots 102 collecting the sensor data may navigate a same route or routes within an environment. In these embodiments, the threshold level may correspond to the neural network 300 being trained to identify a substantial majority of features detected along the route(s) of the one or more robots 102, as illustrated in FIG. 7 below.

According to at least one non-limiting exemplary embodiment, a neural network 300 may be further trained using sensor data which does not comprise any of the training features. Use of training pairs which do not comprise any training features may further enhance the model 408 by reducing a potential for false positive detection as appreciated by one skilled in the art. In some embodiments, a “background,” “default,” “other,” and similar classifications for portions of an RGB image (e.g., white portions of annotations 508 of FIG. 5 above) may be considered as training feature, wherein providing images representing no training features other than “background,” “default,” or “other” classifications may be further utilized to train the neural network 300 to identify regions of RGB images corresponding to background or other default classification. For example, providing a neural network 300 trained to identify cats and dogs within RGB images with an image comprising no cats or dogs may yield an output of “cat” or “dog” if the neural network 300 is not trained to identify “background” or “not cat nor dog” pixels.

Upon processing device 130 determining the neural network 300 is trained above a threshold level, processing device 130 moves to block 610.

Upon processing device 130 determining the neural network 300 is not trained above a threshold level, processing device 130 moves to block 602. Block 602 through 608 may be illustrative of a training process for a neural network 300 which may require a plurality of training input/output pairs such that optimal weights of intermediate nodes 306 may be determined, the training pairs being provided from the sensor data collected by the robots 102 and annotations from the annotator 404.

Block 610 illustrates processing device 130 communicating a trained model 408 to one or more robots 102. The trained model 408 corresponding to the weights of intermediate nodes 306 of the neural network 300 learned during the training process illustrated in blocks 602-608, wherein the adjective “trained,” as used herein, corresponds to the model 408 achieving a training level above the threshold of block 608. The trained model 408 may be communicated to one or more robots 102 which communicate sensor data in block 602 and/or different robots 102 coupled to the cloud server 202.

Advantageously, the method 600 may enable a cloud server 202 in conjunction with an annotator 404 to generate training data for use in training a neural network 300, wherein the training data is collected by a plurality of autonomous robots 102. Use of robots 102 to collect the training data enhances reliability of data acquisition as robots 102 may operate (i.e., collect sensor data) at any time of day autonomously given a command to do so (e.g., from cloud server 202 or an operator of robot 102). Additionally, use of robots 102 may further enhance quality of the sensor data collected as, for example, robots 102 may be commanded (e.g., by cloud server 202 or controller 118) to move closer/farther to/from features to capture higher resolution images, scans, or more accurate measurements of the features autonomously. Some contemporary methods utilize humans to capture images of the training features, which may be costly from a time and labor perspective when compared to using robots 102 which may already operate within an environment. That is, robots 102 may collect the sensor data during normal operation, thereby imposing little additional cost for acquisition of training data using preexisting robots 102. Further, training the neural network 300 may utilize a substantial amount of computing resources, which may not be available on every robot 102, wherein training of the neural network 300 external to the robot(s) 102 (e.g., on a distributed network of processing devices) which utilize the trained model 408 may enable robots 102 with low computing resources to utilize trained models to identify features. Identification of features may further enhance operations of robots 102 by enabling the robots 102 to better select tasks and improve task performance in response to the identifications of the features. For example, a cleaning robot 102 may utilize a trained model 408 to identify things and/or places to clean from RGB images, such as dirt, puddles, and the like. Identification of features may further enhance utility of robots 102 to their respective operators. As an example, a cleaning robot 102 may utilize a trained model 408 to identify and localize items on a supermarket shelf for use in ensuring items are in stock as the robot 102 cleans nearby the shelf, wherein the cleaning robot 102 is not required to train its own model 408 to perform this additional function. Finally, robots 102 being initialized in environments comprising preexisting robots 102 may be quickly trained to identify features within the environments using models 408, the models 408 being trained using sensor data collected by the preexisting robots 102 and annotations of the sensor data from annotator 404.

FIG. 7 illustrates a graph 700 of uploads of sensor data uploaded to cloud server 202 over time by a robot 102, according to an exemplary embodiment. Uploads of sensor data (i.e., the vertical axis) may comprise a number of bytes per second of the sensor data uploaded by the robot 102 for use in training a model 408 of a neural network 300. The uploads of sensor data may correspond to, at least in part, a bandwidth of communications 402 illustrated in FIG. 4 above. In some embodiments, the graph 700 may illustrate an amount of sensor data an annotator 404 receives and labels for use in training the neural network 300.

The robot 102 may collect the sensor data to be uploaded using one or more sensor units 114, described in FIG. 1A above, as the robot 102 navigates predetermined route(s) and/or performs its typical functions. During navigation of the predetermined route(s), the robot 102 may observe a substantially similar set of features during each subsequent navigation of the predetermined route(s), provided the environment surrounding the predetermined routes does not change substantially. Accordingly, uploads (i.e., communications 402) may be substantially large during initial training of the neural network 300 as the neural network 300 may initially utilize any sensor data which represents training features in any way (e.g., from any angle, distance, lighting conditions, etc.) to train the neural network 300. At later times, the uploads may decrease corresponding to the robot 102 not observing the training features in a substantially different way (e.g., from different angles, under different lighting conditions, etc.) during repeated navigation of the predetermined route(s). The neural network 300 may be trained, using a system 400 of FIG. 4 and method 600 of FIG. 6 above, using the sensor data uploaded to the cloud sever 202 and annotations of the sensor data from an annotator 404.

Over time, the robot 102 may continue to navigate the same predetermined route(s), wherein additional annotations of the sensor data collected by sensor units 114 of the robot 102 may not substantially change weights of intermediate nodes 306 of the neural network 300. This may be due to robot 102 not capturing sensor data which represents the training features in different ways (e.g., from different angles, distances, resolutions, lighting, etc.) from how the training features were represented in sensor data collected during previous navigation of the routes. Accordingly, a substantial drop 702 in upload data may occur at some time t_{drop} after the training process beings at time zero (e.g., after 2, 3, 4, etc. repeat navigations of a same route). Threshold 704 may correspond to the neural network 300 being trained to identify the training features with sufficient accuracy (e.g., 90%, 95%, etc.), similar to the training level threshold of block 608 illustrated in FIG. 6 above. Time t_{deploy} may correspond to a time, after the drop 702 at time t_{drop}, at which the neural network 300 is sufficiently trained to identify the training features and the corresponding model 408 is communicated, via communications 410, to one or more robots 102. Some additional feature data may continue to be communicated to the cloud server 202 after time t_{deploy} for use in further training of the neural network 300, the additional feature data comprising, at least in part, edge cases (e.g., bad lighting, reflections, unique perspectives of training features, etc.) where the model 408 fails to produce correct outputs. These edge cases may be utilized for further refining (i.e., training) of the model 408. That is, graph 700 does not asymptotically approach zero in all embodiments. It is appreciated that model 408 may be continuously updated after the model 408 is deployed, at time t_{deploy}, onto one or more robots 102, wherein the cloud server 202 may communicate updates to the model 408, via communications 410, to the one or more robots 102.

According to at least one non-limiting exemplary embodiment, upload data reaching a threshold level 704 may correspond to the neural network 300 being sufficiently trained to identify the training features sensed by the robot 102 during navigation of one or more routes repeatedly. Stated differently, threshold level 704 corresponds to a neural network 300 being sufficiently trained to identify all training features sensed by the robot 102 using sensor units 114, wherein the model 408 of the trained neural network 300 may be communicated to the robot 102 for by the robot 102 to identify the training features within data collected by the sensor units 114. Data uploaded after time t_{deploy} may include edge cases (e.g., cases where the models 408 fail to identify features) and/or instances where new features (e.g., new products to a retail store) to be identified are introduced into the environment.

According to at least one non-limiting exemplary embodiment, the threshold level 704 may correspond to an indication to the cloud server 202 that feature data collected by a first robot 102 is not of substantial value for further training of the neural network 300. In this embodiment, the cloud server 202 may utilize sensor data collected by other robots 102, the other robots 102 observing, using sensor units 114, the same training features as the first robot. The other robots 102 may, however, observe the same training features in a different way from the first robot 102. That is, a neural network 300 may be trained using sensor data collected by a plurality of robots 102, wherein each of the plurality of robots 102 may decrease uploads of sensor data to the cloud server 202 upon the neural network 300 being sufficiently trained to identify the training features within data collected by the plurality of robots 102. The cloud server 202 may evaluate the accuracy of the neural network 300 using a training threshold, such as a correctness rating described in block 608 of FIG. 6 above, prior to communicating the model 408 to one or more robots 102.

According to at least one non-limiting exemplary embodiment, upload data may temporarily increase at a time after t_{deploy} such as, for example, when a robot 102 navigates a new route and observes the training features in a different way (e.g., different perspectives) and/or observing new features which may be further utilized in training additional neural networks 300 or expanding capabilities of existing neural networks 300. Observation of the training features in a different way (e.g., from a different angle, distance, etc.) may be useful in further training of a neural network 300, wherein an annotator 404 may label sensor data collected during navigation of the new route for further training of the neural network 300. That is, upload data constantly decreasing at all times after drop 702 is not intended to be limiting. To illustrate, a robot 102 may normally capture images of features at midday, wherein its models 408 are trained to identify the features under midday lighting conditions. If the robot 102 executes the same route at night for a first time, the models 408 may fail to identify the features under the new lighting conditions, thereby causing the controller 118 of the robot 102 to upload more sensor data of these features under the new (nighttime) lighting conditions to further train the neural networks 300 to identify features both under midday and nighttime lighting conditions.

According to at least one non-limiting exemplary embodiment, drop 702 may indicate to a sever 202, or processing devices thereof, that a substantial amount of sensor data collected by the robot 102 is no longer of use for training of a neural network 300. Due to robots 102 navigating predetermined routes, there may exist a limit on a number of features observed by the robots 102 during navigation of the predetermined routes corresponding to drop 702 of uploads of feature data from the robots 102. There may also be a limit on a number of ways of representing the features (e.g., from different angles, using different lighting, etc.) during navigation of the same predetermined routes. That is, there may exist a limit on a number of useful sensor data inputs of which labels thereto may be of use for training the neural network 300. Cloud server 202 may, in this embodiment, communicate the trained model 408 to one or more robots 102 upon determining a threshold number of robots 102 upload sensor data which is not of substantial use in training of the neural network 300 (i.e., training of the model 408).

Advantageously, use of robots 102 to collect sensor data for use in training a neural network 300 may further reduce bandwidth of communication 402 as the robots 102 may navigate a same predetermined route(s) and observe substantially similar features during each navigation of the predetermined route(s). For example, neural network 300 may be trained (i.e., weights of nodes are adjusted) to identify objects within RGB images. Providing the neural network 300 with a plurality of images of one object does not enhance the ability of the neural network 300 to identify different objects. Accordingly, only images where a new or unseen object is detected may be of use for further training of the neural network 300 to identify objects, causing a substantial decrease in data required to train the network also known as the model converging. Convergence of a model drastically reduces the amount of further training data needed to enhance the accuracy of a neural network 300 over time. This is caused, in part, because some robots 102 operate in a substantially similar and/or repetitive environment. It is appreciated that some data may still be uploaded to the cloud server 202 by one or more robot 102 to further enhance the model, however this data is substantially less than the data used to initially train the model (e.g., a new object is seen, robot 102 is in a unfamiliar situation/location, etc.).

FIG. 8 illustrates an exemplary implementation of the systems and methods of the present disclosure for use in identifying features 812 using data collected by a sensor unit 114 of a robot 102, according to an exemplary embodiment. The robot 102 may comprise a drone, or other land surveying robot 102, comprising limited computing power (e.g., to minimize weight of land surveying robot 102). Sensor unit 114 may collect measurements (e.g., RGB images, point clouds, etc.) within field of view 810. The measurements (i.e., sensor data representing, at least in part, features 812) may be communicated via communications 802 to a cloud server 202, the communications 802 comprising wireless communications.

Cloud server 202 may transmit the measurements via communications 804 to one or more robots 102 and/or robotic networks 210 coupled to the cloud server 202. Robots 102 which receive communications 804 comprise a model 408 trained to identify at least the features 812, the features 812, in this embodiment, being trees on a landscape. Using the trained model 408, the input measurements (e.g., RGB images, point clouds, etc.) may be processed such that the features 812 are identified using the trained model 408. Upon identification of the features 812 using the trained model 408, the one or more robots 102 and/or robot networks 210 may communicate, via communications 806, the inference (i.e., output of model 408 for the input measurements of feature data) back to the cloud server 202. The inference comprising, at least in part, identification of features 812. The cloud server 202 may further utilize a position of the land surveying robot 102 during acquisition of the measurements to localize each feature 812, the localization being illustrated using a bounding box 814. Cloud server 202 may utilize communications 808 to communicate identification of features 812 as well as locations of respective bounding boxes 814 for the features 812. The land-surveying robot 102 may plan its trajectory in accordance with the identified and localized features 814 (e.g., navigate closer to identified trees 812 to monitor tree growth, health, etc.).

It is appreciated that robots 102 performing the inference using a trained model 408 to process feature data collected by the land surveying robot 102 is not intended to be limiting to robots 102 spatially separated from the land surveying robot 102. Additionally, the use of identifying trees 812 is not intended to be limiting. For example, various robots 102 of network 210 may identify power lines, birds, airplanes, or other objects simultaneously which may enable the land surveying robot 102 to change its trajectory to avoid these identified hazards. Advantageously, the land surveying robot 102 may now identify a plurality of features with little additional work load imposed on its controller 118. Further, identification of a plurality of features may not be possible on robots 102 with low computational resources (e.g., memory, processing speed, etc.).

According to at least one non-limiting exemplary embodiment, data of communications 802 may be utilized as training data to train one or more neural networks 300 in addition to being utilized to aid in navigating the land surveying robot 102. In some embodiments, robots 102 of robot network 210 utilize unused processing bandwidth (e.g., idle robots 102) to train the one or more neural networks 300.

By way of an illustrative non-limiting exemplary embodiment, a supermarket may comprise two robots 102, a first robot 102 may be cleaning a floor while a second robot 102 is idle in the supermarket. The second robot 102 may receive sensor data from sensor units 114 of the first robot 102 (via communications units 116), utilize a trained model 408 to process the sensor data, and communicate to the first robot 102 any/all identified training features within the sensor data received from the first robot 102. The identified features may, for example, comprise of identified regions of dirty floor for the first robot 102 to clean, the regions being identified in RGB images captured by sensor units 114 of the first robot 102, thereby enabling the second idle robot 102 to aid the cleaning performance of the first robot 102. As a similar example, the second robot 102 may comprise significantly more computing power than the first robot 102 such that the second robot 102 my process sensor data collected by the first robot 102 using a trained model 408 during operation of the first and second robot 102. It is appreciated by one skilled in the art that FIG. 8 illustrates an exemplary implementation of the broader systems and methods of the present disclosure for training a model 408 and utilizing the model 408 to perform inferences for sensor data collected by a first robot 102, the inference being performed by other robots 102 using the model 408, and is not intended to be limiting to use in land surveying.

Advantageously, little to no processing is performed by the land surveying robot 102 as all training of the model 408 and inference (i.e., utilization of the model 408) is performed by a distributed network of processing devices 130 and/or controllers 118 which are, in part, separate from controller 118 of the land surveying robot 102. Additionally, the robots 102 and/or robot networks 210 which perform the inference (i.e., utilize model 408 given input measurements from the land surveying robot 102 to identify features 812) may comprise robots 102 and/or robot networks 210 which are idle and/or comprise unused computing resources, thereby further enhancing the utility of the robots 102 during idle times.

According to at least one non-limiting exemplary embodiment, robots 102, which perform the inference using a trained model 408 to identify features 812 within sensor data collected by land surveying robot 102, may train the model 408 (i.e., train the neural network 300). For example, the robots 102 may be idle such that controllers 118 comprise unused computing resources. Cloud server 202 may utilize this unused computing power to train the model 408, the model 408 being later used to identify features 812 sensed by a sensor unit 114 of the land surveying robot 102.

The above disclosure illustrates systems and methods for training a neural network 300 using data collected by one or more robots 102 and advantages thereof. One skilled in the art may appreciate that a single robot 102 may, however, observe a substantial number of features during normal operation. For example, robots 102 operating in supermarkets may observe 10,000 different products or more, wherein each product may be considered as a feature. It may be impractical to train a single neural network 300 to identify all of the features observed by the robot 102. Accordingly, FIG. 9A illustrates a system 900, which expands upon system 400, configurable to train a plurality of neural networks 300 using sensor data collected by one or more robots 102, according to an exemplary embodiment.

Communication 402 comprises sensor data collected by the one or more robots 102. The sensor data may comprise, without limitation, RGB images depth encoded images, LiDAR point cloud scans, measurements of time dependent parameters (e.g., temperature), cellular and Wi-Fi signal strength measurements, and so forth. Annotator 404 may annotate the sensor data from communications 402 and output the annotations of the sensor data to communication 406. Communications 402, 406 may comprise wired and/or wireless communication channels. As the robots 102 navigate predetermined route(s), the sensor data may be uploaded to the annotator 404 via a processing device 130 of the cloud server 202 executing computer readable instructions. For each respective robot 102 collecting the feature data of communication 402, a drop or decrease 702 in upload data (i.e., bytes uploaded per second) may be observed as the robots 102 navigate a same set of routes many (e.g., three or more) times, wherein the robots 102 navigating a same route many times may observe substantially fewer new features and/or fewer different representations of the training features (e.g., from different angles, different distances to the features, etc.) during subsequent navigation of the same route. Accordingly, annotator 404 may be required to label substantially fewer images, point clouds, and/or other feature data inputs of communication 402 as time progresses due to the robots 102 navigating the same set of routes.

Annotator 404 may output annotations of sensor data collected by robots 102 to a selection unit 902 via communications 406. Selection unit 902 may comprise a look-up table, multiplexer, or computer readable instructions executed by processing device 130 configurable to receive the feature data from the robots 102 and annotations of the feature data from annotator 404 and determine which neural network(s) 300 may utilize the training pair. A training pair, as used herein, may comprise any pair of sensor data and annotations for the sensor data for use in training a neural network 300 to identify training features within the sensor data, the training features being denoted using the annotations from the annotator 404. For example, annotator 404 may provide annotations for a given input image from a RGB camera sensor unit 114 of a robot 102 operating in a supermarket, the annotations may comprise “milk,” “soda,” “candy,” and/or any other features observed by the robot 102 within the supermarket. Accordingly, selector 902 may output the training pair to neural network(s) 300 configurable to identify the supermarket items within RGB images.

Each neural network 300 may generate a respective model 408, the models 408 being trained using training pairs provided by sensor units 114 of robots 102 and annotator 404 as discussed above. Each of these models 408 may be deployed onto (i.e., communicated to) one or more robots 102 for use in enhancing functionality of the one or more robots 102. The models 408 may be utilized by one or more robots 102 to perform inferences on sensor data collected by other robots 102, as illustrated in FIG. 8 above. In some instances, the robots 102 which upload the sensor data to the cloud server 202 via communication 402 may be the same or different robots 102 which receive one or more of the models 408.

According to at least one non-limiting exemplary embodiment, the plurality of models 408 may be represented as a single model 408 which combines all outputs of all of the neural networks 300. That is, the single model 408 may be utilized to represent detections of features within a given input of sensor data from a robot 102, the detection of features being performed by one or more of the neural networks 300. According to at least one non-limiting exemplary embodiment, a model 408 communicated via communications 410 to one or more robots 102 may comprise an aggregation of any two or more models 408 of any two or more respective neural networks 300. For example, a model 408 trained to identify humans and a model 408 trained to identify cars may be communicated as a single aggregated model 408, configurable to identify humans and cars, to one or more robots 102 via communications 410. Aggregation of two or more models 408 into a single model 408 may further comprise processing device 130, or a distributed network of processing devices/controllers, executing specialized algorithms via computer readable instructions from a memory.

According to at least one non-limiting exemplary embodiment, selection unit 902 may be configurable to filter communications 402 prior to the communications 402 being received by an annotator 404. The selection unit 902 may further be illustrative of computer readable instructions executed on individual robots 102 prior to the individual robots 102 uploading the sensor data to the cloud server 202. That is, selection unit 902 may be illustrative of a filtering operation performed by the robots 102 prior to the robots 102 uploading sensor data, via communications 402, to the cloud server 202 and annotator 404.

Advantageously, the system 900, which follows substantially similar principles as system 400 illustrated in FIG. 4 above, may be utilized to train a plurality of models 408, each model 408 being configurable to identify one or more training features. Alternatively, the system 900 may be configurable to train a single, comprehensive model 408 comprising an aggregation of all models 408 derived from all the neural networks 300. Collection of input sensor data (e.g., images, point clouds, and/or measurements) using robots 102 may enhance reliability, quality, and consistency of the data collection as robots 102 may reliably and repetitively collect sensor data of the training features, wherein the robots 102 may position themselves autonomously (e.g., using actuator units 108) to ensure the sensor data acquired is of high quality. Use of a selection unit 902 may reduce computational resources utilized by the neural networks 300 during training by only providing the neural networks 300 with training pairs which represent features of which the respective neural networks 300 are trained to identify. That is, selector 902 may be representative of a filtering unit. Use of a selection unit 902, however, may not be a limiting requirement in every embodiment of system 900, provided sufficient computing power is available to train every neural network 300 with every input of sensor data and annotations of the sensor data. It is appreciated that any operative unit (e.g., 902, 300) of cloud server 202 may be illustrative of a distributed network of processing devices/controllers 118 executing computer readable instructions, wherein the processing devices of the distributed network of processing devices/controllers 118 exist on devices 208 and robots 102 coupled to the cloud server 202. For example, selection unit 902 may be illustrative of a filtering operation performed by each individual robot 102 during uploading of sensor data, via communication 402, to the cloud server 202 (e.g., robot 102 may upload only images, or other sensor data types, at substantially different times and/or locations and refrain from uploading images substantially similar to other images uploaded to the cloud server 202).

FIG. 9B illustrates a histogram 904 comprising a vertical axis representing probability values ranging from zero (0) to one (1) and a horizontal axis representing N training features, N being any integer number, according to an exemplary embodiment. Training features correspond to features of which neural networks 300 (i.e., models 408) of system 900 are trained to identify within sensor data. That is, histogram 904 may represent outputs of models 408 of system 900 illustrated in FIG. 9 above for a given input of sensor data, the outputs comprising a probability that a respective feature is present within the given input of sensor data. The input of sensor data may comprise a single image, scan, or measurement collected by a sensor unit 114. One or more robots 102, devices 208, and/or processing devices 130 of cloud server 202 may utilize models 408 to perform the inferences on the input of sensor data to determine probabilities of the histogram 904. Probability p corresponds to a probability that a given training feature exists within a given sensor input, the training features being detected by one or more models 408 trained using a system 900 illustrated in FIG. 9A above. The histogram 904 may comprise a detection threshold 906, wherein a training feature comprising a probability p above the detection threshold 906 corresponds to the training feature being present within the given sensor input. As illustrated, training features h, i, and j exist within the given sensor input (e.g., within an image captured by a robot 102), wherein the training features h, i, and j may correspond to any feature within an environment of the robot 102 (e.g., car, road, train, person, cat, dog, etc.). The histogram 904 may be further utilized to determine when sensor data from a robot 102 should be uploaded to sever 202, to which neural network 300 the sensor data should be processed by and/or used to train, and/or when additional labels by annotator 404 are required to enhance accuracy of the models 408.

According to at least one non-limiting exemplary embodiment, histogram 904 may comprise all probability values below the threshold 904. This may correspond to a given sensor input (e.g., an image) comprising either none of the N training features or different representations of the training features (e.g., under different lighting conditions, sensed from different angles and distances, etc.) of which the models 408 are not trained to process or fails to identify, respectively. Upon detecting no features comprise a probability p exceeding threshold 904, robot 102 may utilize communications 402 (via communications units 116) to provide the sensor input to an annotator 404, wherein the annotator 404 may provide labels to the sensor input for use in further training of one or more of the neural networks 300. Advantageously, threshold 904 may reduce data communicated to annotator 404 over time as only edge cases (e.g., images with bad lighting, unique angles, etc.) of representing the training features are communicated to the annotator 404. This is advantageous as annotating or labeling images, or other sensor data types (e.g., point clouds), may be costly from both a time and labor perspective.

Histogram 904 may be stored in a non-transitory memory (e.g., memory 132) and modeled over time and as a function of position of a robot 102. That is, a position of a robot 102 within its environment may be correlated to features observed by the robot 102, the features observed being indicated by histogram 904. It is appreciated that robot 102 may localize itself during acquisition of sensor data uploaded to cloud server 202 via communication 402, wherein the localization may be communicated as metadata or as a separate input to the cloud server 202 for use in determining peaks 910 of a dynamic filter 908 as illustrated next in FIG. 9C.

FIG. 9C illustrates an implantation of a discrete brick-wall filter 908 for use by a robot 102 collecting sensor data of its environment as a means for reducing bandwidth of communications 402 to cloud server 202, according to an exemplary embodiment. The filter 908 may comprise a maximum amplitude of unity (1) and a minimum value of zero. The filter 908 may comprise one or more peaks 910 comprising amplitudes of unity (1), wherein each peak 910 may correspond to a training feature being present at a current position of the robot 102 based on prior values of histogram 904. For example, robot 102 may operate within a supermarket and localize itself within a cereal aisle, wherein the three peaks of filter 908 may correspond to three types of cereals observed within the cereal aisle during prior navigation through the aisle, each of the three cereal types being a respective one of the training features. Accordingly, filter 908 may comprise peaks 910 encompassing the three cereal features detected within the cereal aisle while robot 102 is within the cereal aisle. The width of each peak 910 may encompass at least one feature.

According to at least one non-limiting exemplary embodiment, histogram 904 may exist as a discrete set of values rather than a continuous curve. In this embodiment, filter 908 may comprise peaks 910 represented by a Dirac delta function, as appreciated by one skilled in the art.

Peaks 910 of the filter 908 may move along the horizontal axis based on a position of the robot 102 as the robot 102 navigates through its environment. Additional or fewer peaks 910 may exist for features observed by a robot 102 at other locations. For example, robot 102 may first navigate within the cereal aisle and may observe the three features i, k, and j. The robot 102 may subsequently navigate to a different aisle, such as a pet food aisle, and observe different training features, wherein the peaks 910 of filter 908 may be moved, added, or removed accordingly to encompass the different training features (e.g., to encompass dog food, cat food, fish foods, pet toys, etc.) observed within the pet food aisle. Peaks 910 of filter 908 at a location of a robot 102 may correspond to one or more trained models 408 of which sensor data captured at the location of the robot 102 may be communicated to, wherein the robot 102, in this embodiment, may utilize one or more models 408 configurable to at least identify features i, j, and k.

As illustrated, feature k of histogram 904 was not detected within a sensor input of the robot 102 at a present location of robot 102, wherein feature k, along with features i and j, were detected at the present location during prior navigation at prior times at the present location. This is indicated by peak 910 of the filter 908 encompassing feature k, but a point of histogram 904 corresponding to feature k is not above the detection threshold 906. Accordingly, robot 102 may perform a task in accordance with the detection of the missing feature k (e.g., restocking an item if feature k corresponds to the item on a shelf display within a store).

According to at least one non-limiting exemplary embodiment, the task performed by robot 102 may comprise a physical action in accordance with the identified missing feature. For example, the missing feature k may correspond to a missing item on a supermarket shelf, wherein the robot 102 may restock the item or alert a store associate of the missing item (e.g., by sending a wireless signal to a cell phone of the associate). This may not require communications 402 to the cloud server 202, thereby reducing bandwidth occupied by the robot 102 uploading the sensor data to the cloud server 202.

According to at least one non-limiting exemplary embodiment, feature h is detected at the present location of the robot 102, wherein the prior inferences using model 408 predict that feature h should not be present at the location based on prior values (i.e., peaks) of histogram 904. This is indicated by filter 908 not comprising a peak 910 encompassing the feature h. In some instances, detection of the feature h may configure the robot 102 to perform a task, such as relocate the feature h if, for example, feature h comprises a misplaced object. In some instances, an additional peak 910 of filter 908 may be added to encompass feature h if feature h is detected within sensor data collected at the location at future and/or past times. In some instances, feature h should not be detected at all (e.g., feature h has never been detected by robot 102 in the past) wherein robot 102 may utilize communication 402 to cloud server 202 to upload the sensor data collected at its present location for use in further training neural networks 300.

According to at least one non-limiting exemplary embodiment, threshold 906 comprises a dynamic threshold comprising a probability value which changes in time, as a function of position of robot 102, and/or based on a mean probability of the histogram 904. In other non-limiting exemplary embodiments, threshold 906 may comprise a fixed probability value between zero and one.

Advantageously, use of a histogram 904 modeled over time and a dynamic filter 908 may provide a reduction in data communicated to the cloud server 202 via communications 402, thereby reducing overall bandwidth occupied by the communications 402. Reduction of bandwidth occupied may reduce costs of robots 102 operating on cellular networks (e.g., 3G, 4G, 5G, and/or variants thereof) and/or may facilitate additional robots 102 to operate within a same environment. Reduction of bandwidth of communications 402 (i.e., reduction in an amount of sensor data uploaded to cloud server 202) may further reduce a number of labels annotator 404 is required to provide in order to train a neural network 300, thereby saving time, money and labor as labeling the sensor data may be costly from a time, labor, and monetary perspective. Further, dynamic filter 908 may enable robots 102 to make decisions based on training features observed in the past and changes to the training features observed over time (e.g., changes in position), thereby enhancing autonomy of the robots 102.

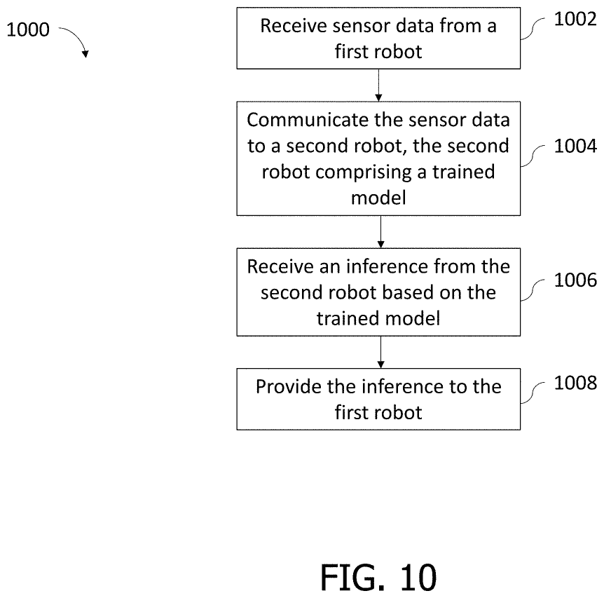

FIG. 10 is a process flow diagram illustrating a method 1000 for a cloud server 202 to utilize a second robot 102, comprising a trained model 408 using system 900 illustrated in FIG. 9 above, to perform an inference using sensor data collected by a first robot 102, according to an exemplary embodiment. An inference, as used herein, may comprise any identification of features, predicted values, and/or any other parameters of which model 408 may be utilized to generate using the sensor data collected by the first robot 102 as an input to the model 408. It is appreciated that any steps of method 1000 performed by the cloud server 202 comprises a distributed network of processing devices 130 and/or controllers 118 of robots 102 and/or devices 208 executing computer readable instructions, the instructions may be stored on respective non-transitory memories or communicated to the processing devices/controllers from the cloud server 202.

Block 1002 illustrates the cloud server 202 receiving sensor data from the first robot 102. The sensor data may comprise any measurement or scan by a sensor unit 114 such as, without limitation, RGB images, point cloud scans, discrete measurements of parameters (e.g., temperature, population density, Wi-Fi coverage, etc.), and/or any other data type collected by a sensor unit 114 which may represent one or more features.

Block 1004 illustrates the cloud server 202 communicating the sensor data to the second robot 102. The second robot 102 comprises a trained model 408 configurable to receive the sensor data and generate an inference corresponding to a detection, location, and/or presence of a training feature within the sensor data.

According to at least one non-limiting exemplary embodiment, block 1004 may further comprise of the cloud server 202 communicating the trained model 408 to the second robot 102 if the second robot 102 does not already comprise the trained model 408 stored in a memory 120. The second robot 102 being chosen from a plurality of robots 102 communicatively coupled to the cloud server 202 based on the second robot 102 comprising unused computing resources (e.g., the second robot 102 is idle). The second robot 102 may similarly be illustrative of two or more robots 102 performing the inference using the trained model 408.

Block 1006 illustrates the cloud server 202 receiving an inference from the second robot 102, the inference being based on outputs of the trained model 408. A controller 118 or processing device 130 of the second robot 102 may execute computer readable instructions to input the received sensor data into the trained model 408, wherein the inference corresponds to an output of the trained model. The inference may comprise a detection of one or more training features, training features corresponding to features of which the model 408 is trained to detect.

Block 1008 illustrates the cloud server 202 providing the inference to the first robot 102. The inference may enable the first robot 102 to plan its trajectory, task selection, task execution, and/or movements based on features detected within the sensor data, wherein the detection of the features corresponds to the inference.

According to at least one non-limiting exemplary embodiment, the second robot 102 of method 1000 may be illustrative of two or more robots 102 comprising the trained model 408 and/or comprising unused computing resources. Similarly, the second robot 102, at least in part, may be illustrative of one or mode devices 208 utilizing the model 408, in conjunction with one or more robots 102, to process the sensor data received from the first robot 102. That is, the inference may be performed by any number of robots 102 and/or devices 208 communicatively coupled to the cloud server 202, as illustrated in FIG. 2 above.

According to at least one non-limiting exemplary embodiment, block 1008 may comprise the cloud server 202 communicating the inference to a third robot 102 in addition to or instead of communicating the inference to the first robot 102.

According to at least one non-limiting exemplary embodiment, both the first and second robots 102 may exist within a same environment (e.g., both robots 102 operating on a same Wi-Fi network, building, room, etc.) and/or be communicatively coupled directly to each other (e.g., over Wi-Fi), wherein method 1000 may be performed independent of the cloud server 202 in an effort to reduce communication bandwidth between the cloud server 202 and the robots 102. That is, the first robot 102 may directly communicate sensor data to the second robot 102 and the second robot 102 may directly communicate the inference back to the first robot 102 without communicating either the sensor data or inference to the cloud server 202.

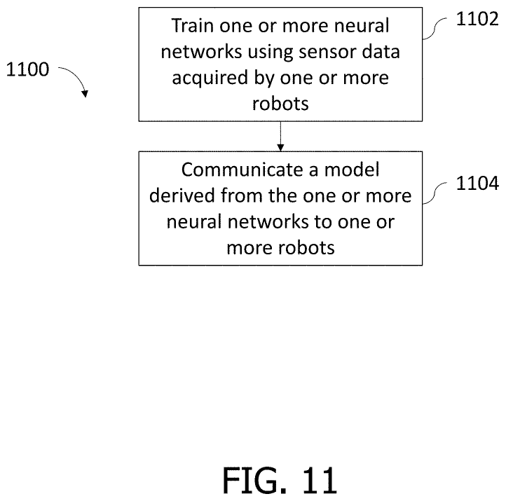

FIG. 11 is a process flow diagram broadly illustrating methods disclosed herein, according to an exemplary embodiment. Method 1100, illustrated in FIG. 11, may be performed by a cloud server 202, wherein the cloud server 202 may comprise a hardware and/or software entity separate from robots 102 coupled thereto or may be comprised of a distributed network of processing devices/controllers 118 of devices 208 and robots 102, respectively, coupled thereto. Steps of method 1100 may be effectuated by one or more processing devices of the cloud server 202 (e.g., one or more processing devices/controllers of the distributed network) executing computer readable instructions from a memory.

Block 1102 comprises the cloud server 202 training one or more neural networks 300 using sensor data acquired by one or more robots 102 coupled to the cloud server 202, as illustrated in FIG. 2 above. The training of the one or more neural networks 300 may comprise the cloud server 202 receiving sensor data from sensor units 114 of the one or more robots 102, providing the sensor data to an annotator 404 configurable to label the sensor data, and utilizing the sensor data and associated labels thereto to train the one or more neural networks in accordance with a training process described in FIG. 3 above. In some instances, the sensor data may comprise RGB images, the labels may comprise annotations features within the RGB images (e.g., annotated regions corresponding to a “car,” “boat,” “road,” etc.). In some instances, the sensor data may comprise point clouds and the labels may comprise three-dimensional regions classified as one or more features. In some instances, the sensor data may comprise measurements of a time dependent parameter, such as temperature, position of an object over time, velocity of an object, cellular/Wi-Fi coverage (i.e., signal strength), and the like, wherein the measurements may be collected over time and utilized to train a neural network 300 to predict future values of the time dependent parameter. Other formats of sensor data which may be utilized to train one or more neural networks 300 are considered without limitation, as appreciated by one skilled in the art.

Block 1104 comprises the cloud server 202 communicating a model 408 derived from the one or more neural networks 300 to one or more robots 102. The model 408 may be derived from weights of intermediate nodes 306 (and in some instances, input nodes 302 and output nodes 310) in accordance with equation 1 above and the training process described in block 1102. The model 408 may be derived from a single neural network 300. For example, a neural network 300 may be trained to develop a model 408 configurable to identify humans within RGB images or point cloud data, wherein one or more robots 102 may utilize this human detection model 408 to detect humans. In some instances, the model 408 may be an aggregation of two or more models 408 for two or more respective neural networks 300. For example, a first neural network 300 may be trained to identify humans within RGB images and a second neural network 300 may be trained to identify cats within RGB images, the first and second neural networks 300 may yield models 408 configurable to respectively identify humans and cats, wherein the model 408 communicated to the one or more robots 102 may be an aggregation of the two models 408 being configurable to identify both humans and cats within RGB images. It is appreciated that the model 408 is configurable to identify features observed by the one or more robots 102 of which the model 408 is being communicated to (e.g., a robot 102 operating within a grocery store may not require the model 408 to be configurable to identify trees to enhance functionality of the robot 102) and may comprise an aggregation of any two or more models 408 derived from any two or more respective neural networks 300. The model 408 may be communicated to the one or more robots 102 via communications 410, comprising a wired and/or wireless communication channel. The one or more robots 102 which receive the model 408 may be the same or different robots 102 which provide the sensor data in block 1102.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

The systems and methods of this disclosure advantageously enhance functionality of robots 102 by enabling the robots 102 to identify features within RGB images, point cloud data, and other data formats. Identification of features may be useful, and in some instances essential, for robots 102 to effectively perform their functions. For example, a cleaning robot 102 may utilize a trained model 408, configurable to identify areas to clean (e.g., dirt on a floor), to identify the areas to clean and correspondingly navigate to the areas and clean them. In another aspect, a model 408 may be trained to identify hazardous features, such as escalators, elevators, or other features of an environment of which a robot 102 navigating nearby or onto may be hazardous (i.e., risk damage) to the robot 102, nearby objects, and/or nearby humans, the hazardous features may be identified after the robots 102 have been initialized within the environments. For example, a host 204 of a cloud server 202 may identify a feature unique to some environments of some robots 102 operating therein which may be a hazard, such as escalators for robots 102 operating within multi-level shopping malls. Accordingly, the host 204 may configure a neural network 300, utilize sensor data acquired from the robots 102 (e.g., RGB images of escalators) to train the neural network 300 to identify the hazardous features, and communicate a model 408 derived from the neural network 300, upon the neural network 300 achieving a threshold level of accuracy (described in block 608 of FIG. 6 above), to the robots 102 such that the robots 102 may identify the hazardous features and avoid them. Thereby enabling a host 204, or other operator or manufacturer of robots 102, to configure models 408 unique to certain environments after robots 102 are initialized within the environments from a remote location. In another aspect, models 408 may be trained to enable robots 102 to, in part, operate using only RGB imagery. For example, features, such as navigable floor and unnavigable floor (e.g., carpet, wood, tile, cement, etc.), may be identified such that the robots 102 may plan their trajectories over navigable floor and avoid unnavigable floor types. Contemporary methods within the art may be utilized to localize identified features based on a position of the robots 102 during acquisition of sensor data within which the features are identified (e.g., using binocular disparity, tracking perceived motion of features within multiple images captures as the robots 102 move, etc.). Models 408 may be communicated to individual robots 102 and/or robot networks 210 as a whole. For example, a dirt identification model may be communicated to a network 210 of cleaning robots 102, an escalator detection model 408 may be communicated to a network 210 of robots 102 operating nearby escalators, and so forth. In another aspect, data collection by robots 102 allows for accurate, repeatable, and autonomous data collection without requiring the robots 102 to perform any additional functionality. For example, robots 102 may collect sensor data to be utilized to train a neural network 300 while the robots 102 operate normally. Additionally, robots 102 may be commanded (e.g., by cloud server 202) to move to a specified location autonomously and acquire more sensor data for further training of the neural network 300 if required. These and other advantageous aspects of the present disclosure are appreciated without limitation by one skilled in the art.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. These terms are typically used to account for phenomenon of the physical world which may cause a value to be “substantially close to” or “approximately equal to” an ideal value, these phenomenon include sources of noise, mechanical imperfections, frictional forces, unforeseen edge cases, and other natural phenomenon familiar to one skilled in the art. [need to check if this causes any indefiniteness issues] Also, as used herein “defined” or “determined” may include “predefined” or “predetermined” and/or otherwise determined values, conditions, thresholds, measurements, and the like.

What is claimed is:

1. A method for training neural networks, comprising:
receiving sensor data from one or more sensor units of one or more robots;
receiving labels of the received sensor data, the labels comprising at least one training feature identified within the sensor data;
utilizing the received sensor data and the labels to train one or more neural networks to develop a model to identify the at least one training feature;
communicating the model to one or more robots upon the model achieving a training level above a threshold value;
receiving sensor data from one or more sensor units of a first robot; and
communicating the sensor data received from the first robot to a second robot, the second robot comprising the model trained to identify the at least one training feature.

2. The method of claim 1, further comprising:
generating an inference by the second robot based on the model, the inference comprising detection of the at least one training feature within the sensor data received from the first robot; and
communicating the inference to, at least, the first robot.

3. The method of claim 1, further comprising:
utilizing the model to identify one or more of the training features within sensor data acquired by a robot of the one or more robots at a location;
localizing the robot to the location; and
correlating the location of the robot with the training features observed at the location.

4. The method of claim 3, further comprising:
utilizing the correlation between the location of the robot and the features observed to, during subsequent navigation at the location, determine if at least one of one or more of the training features are missing or one or more additional training features are detected at the location; and
perform a task based on the training features detected at the location deviating from the training features detected at the location during prior navigation at the location, the detection of the training features being performed using the model.

5. The method of claim 4, wherein,
the task comprises at least one of the robot navigating a route, emitting a signal to alert a human or other robots of the change in the observed training features, or uploading sensor data captured at the location for use in enhancing the model.

6. The method of claim 1, further comprising:
receiving sensor data from a third robot;
detecting none of the training features are present within the sensor data using the model; and
receiving labels of the sensor data to further train the model to identify at least one additional feature, the further training of the model comprises training of at least one neural network to identify the at least one additional feature.

7. The method of claim 1, further comprising:
enhancing the model using additional training pairs, the training pairs comprising sensor data acquired by the one or more robots and labels generated for the sensor data subsequent to the communication of the model to the one or more robots; and
communicating changes to the model based on the additional training pairs to the one or more robots which utilize the model.

8. The method of claim 1, wherein,
the model is representative of learned weights of one or more trained neural networks, the one or more neural networks being trained using the labels of the sensor data in accordance with a training process.

9. A system for training neural networks, comprising:
one or more robots, each comprising at least one sensor unit;
one or more processing devices configured to execute computer readable instructions to:
receive sensor data from one or more sensor units of the one or more robots;
receive labels of the received sensor data, the labels comprising at least one training feature identified within the sensor data;
utilize the received sensor data and the labels to train one or more neural networks to develop a model to identify the at least one training feature;
communicate the model to one or more robots upon the model achieving a training level above a threshold value;
receive sensor data from one or more sensor units of a first robot; and
communicate the sensor data to a second robot, the second robot comprising the model trained to identify the at least one training feature.

10. The system of claim 9, wherein the one or more processing devices are further configured to execute the computer readable instructions to:
generate an inference by the second robot based on the model, the inference comprising detection, or lack thereof, of the at least one training feature within the sensor data; and
communicate the inference to, at least, the first robot.

11. The system of claim 9, wherein the one or more processing devices are further configured to execute the computer readable instructions to:
utilize the model to identify one or more of the training features within sensor data acquired by a robot, of the one or more robots, at a location;
localize the robot to the location; and
correlate the location of the robot with the training features observed at the location.

12. The system of claim 11, wherein the one or more processing devices are further configured to execute the computer readable instructions to:
utilize the correlation between the location of the robot and the features observed to, during subsequent navigation at the location, determine if at least one of one or more of the training features are missing or one or more additional training features are detected at the location; and
configure the robot to perform a task based on the training features detected at the location deviating from the training features detected at the location during prior navigation at the location, the detection of the training features being performed using the model.

13. The system of claim 12, wherein,
the task comprises at least one of navigating a route, emitting a signal to alert a human or other robots of the change in the observed features, or uploading sensor data captured at the location for use in enhancing the model.

14. The system of claim 9, wherein the one or more processing devices are further configured to execute the computer readable instructions to:
receive sensor data from a third robot;
detect none of the training features within the sensor data using the model; and
receive labels of the sensor data to further train the model to identify at least one additional feature, the further training of the model comprises training of at least one neural network to identify the at least one additional feature.

15. The system of claim 9, wherein the one or more processing devices are further configured to execute the computer readable instructions to:
enhance the model using additional training pairs, the training pairs comprising sensor data acquired by the one or more robots and labels generated for the sensor data subsequent to the communication of the model to the one or more robots; and
communicate changes to the model based on the additional training pairs to the one or more robots which utilize the model.

16. The system of claim 9, wherein,
the model is representative of learned weights of one or more trained neural networks, the one or more neural networks being trained using the labels of the sensor data in accordance with a training process.

17. The system of claim 9, wherein,
the one or more processing devices comprise a distributed network of processing devices located at least in part on the one or more robots.
